(19) United States
(12) Patent Application Publication
(10) Pub. No.: US 2026/0178871 A1
(43) Pub. Date: Jun. 25, 2026

(54) RFID DEVICES FOR HIGH-DIELECTRIC MATERIALS

(71) Applicant: Avery Dennison Retail Information Services LLC, Mentor, OH (US)

(72) Inventors: Ian J. FORSTER, Chelmsford (GB); Norman A. HOWARD, Ilford (GB); Panagiotis PETRIDIS, Chelmsford (GB); Achimugu A. ATOJOKO, Chelmsford (GB); Muhammad RIZWAN, Chelmsford (GB); Antti T. LESKELÄ, Vesilahti (FI); Adrian N. FARR, Dunmow (GB); Tanzeela MITHA, Rancho Cucamonga, CA (US); Eric L. BARTHOLOMEW, Mill Hall, PA (US); Anna COWFER, Renovo, PA (US); Nishad DHOPATKAR, Lock Haven, PA (US); Kevin O. HENDERSON, Willoughby Hills, OH (US); Alex NYARKO, Williamsport, PA (US); Sivaprakash SHANMUGAM, State College, PA (US); Gang LU, Willoughby, OH (US); Yu-Hsuan LEE, Williamsport, PA (US)

(21) Appl. No.: 19/427,201

(22) Filed: Dec. 19, 2025

Related U.S. Application Data
(60) Provisional application No. 63/736,943, filed on Dec. 20, 2024.
(60) Provisional application No. 63/916,912, filed on Nov. 13, 2025.

(51) Int. Cl. G06K 19/077; H01Q 1/22

(52) U.S. Cl. CPC G06K 19/07786; H01Q 1/2225

(57) ABSTRACT

The present disclosure provides a Radio Frequency Identification (RFID) device comprising an antenna formed from an electrically conductive material, an impedance-matching loop operatively coupled to the antenna, and an integrated circuit (IC) operatively coupled to the impedance-matching loop. The antenna exhibits improved performance when the RFID device is placed on packages containing high-dielectric materials.

### CROSS REFERENCE TO RELATED APPLICATIONS

The present application claims priority to U.S. Provisional Application No. 63/916,912 filed on Nov. 13, 2025, and U.S. Provisional Application No. 63/736,943 filed on Dec. 20, 2024, the entire contents and disclosure of which is hereby incorporated by reference.

### FIELD OF INVENTION

The present disclosure relates to radio frequency identification (RFID) devices and, more particularly, to environmentally adaptable RFID devices designed for efficient operation when placed on or near high-dielectric, lossy materials.

### BACKGROUND

Radio Frequency Identification (RFID) technology has become increasingly important in various industries for tracking and managing products. RFID tags offer several benefits, including improved inventory control, reduced waste, and enhanced product tracking and traceability. However, the performance of RFID tags can be significantly affected by the materials to which they are attached or in close proximity. Lossy and high-dielectric materials are a particular challenge.

One such challenging application is in the food industry and involves using RFID tags with packaged meat or fish products. These products are electrically lossy and have a high dielectric constant, κ. The dielectric constant of a material is the ratio of its permittivity to the permittivity of free space (referred to as “relative permittivity,” εᵣ). Both terms will be used interchangeably herein.

Typically, when a dipole antenna is placed near food proteins with relative permittivity values between 35 and 60, its impedance changes due to interactions with the surrounding medium. The antenna's electric field couples with the protein, and the high permittivity material slows the electromagnetic wave propagation. As a result, the effective wavelength shortens, causing the resonant frequency to shift downward. In other words, the dipole antenna resonates at a lower frequency than it would in free space, which adversely affects the RFID tag's ability to transmit a signal that can be successfully received by an accompanying RFID reader.

Another important effect is that the dipole demonstrates a reduction in radiation resistance when it is near high-permittivity materials. It is believed that this occurs because the dielectric absorbs some of the energy that would typically radiate into free space. Because proteins are both high in permittivity and lossy, they absorb additional energy and convert it into heat, further lowering the antenna's overall radiation efficiency. The challenges are further compounded in scenarios where RFID-tagged products are stacked or densely packed, such as in-store coolers or during transportation. In these situations, the presence of multiple layers of high-dielectric materials between the RFID tag and the reader can significantly attenuate the radio frequency signals, making it difficult to achieve consistent and reliable tag reads.

Additionally, the diverse nature of products in industries such as food retail presents varying dielectric environments. Different types of meats, produce, packaged goods, and other lossy, high-dielectric materials each present unique and specific challenges for RFID tag performance. For example, the high water content of meat absorbs radio waves, particularly in the ultra-high frequency (UHF) band in which RFID tags typically operate. The water in meat also contains salts, which increase the absorptive effect. In other cases, fat is less absorptive than muscle or salt water, so each type of meat (e.g., beef, pork, chicken, fish, etc.), as well as different cuts of each type of meat (e.g., filets, ground meat, etc.), will absorb UHF signals differently. In addition, chicken is often treated with a saltwater brine, making it a particularly challenging application for RFID tags. This variability necessitates RFID solutions that can adapt to a wide range of material properties and environmental conditions.

Furthermore, the physical constraints of product packaging and labeling often limit the size and placement options for RFID tags. This restriction makes it challenging to design antennas that are both compact enough to fit within the available space and efficient enough to perform well in high-dielectric environments.

As the adoption of RFID technology continues to grow across various industries, there is an increasing need for RFID tags that can maintain reliable performance when applied to or used in proximity to high-dielectric, lossy materials. Improved RFID tag designs that can overcome these challenges while remaining cost-effective and suitable for high-volume manufacturing are highly desirable.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In general the embodiments described herein relate to a Radio Frequency Identification (RFID) device that has a reduced magnetic field in the y-axis and/or x-axis. The RFID device includes an antenna formed from an electrically conductive material and an impedance-matching loop operatively coupled to the antenna. The position of the impedance-matching loop may be adjusted with respective to the outer edge of the antenna to reduce the magnetic field in the y-axis and/or x-axis.

According to an aspect of the present disclosure there is provided a Radio Frequency Identification (RFID) device comprising an impedance-matching loop having straps for connecting an integrated circuit chip at each end, wherein the ends of the impedance-matching loop terminate within the impedance-matching loop; and an antenna. The antenna may comprise a curved inner edge surrounding at least a portion of the impedance-matching loop and is separated from the impedance-matching loop by a gap, an outer edge comprising a top edge and a bottom edge on a y-axis of the antenna, and a left edge and a right edge on a x-axis of the antenna, and opposing ends that extend from the bottom portion to the curved inner edge. In some embodiments, the antenna may have a top antenna region arranged between the top portion and the curved inner edge, a bottom antenna region arranged along the opposing ends and between the bottom edge and the curve inner edge, a left antenna region arranged to extend from the left edge to the curved inner edge, and/or a right antenna region arranged to extend from the right edge to the curved inner edge. To achieve improve performance, and in particular, when the RFID device is near or on a package containing a high dielectric materials, there may be a reduced magnetic field interaction in the y-axis and/or x-axis. In one embodiment, the top antenna region has a reduced magnetic field interaction in the y-axis. In one embodiment, the bottom antenna region has a reduced magnetic field interaction in the y-axis. In one embodiment, the left antenna region and/or the right antenna region has a reduced magnetic field interaction in the x-axis.

In some embodiments, there is provided an RFID device comprising the RFID integrated circuit chip and antenna, wherein the antenna comprises an impedance-matching loop having straps for connecting an integrated circuit chip at each end, wherein the ends of the impedance-matching loop terminate within the impedance-matching loop and an antenna comprising a curved inner edge surrounding at least a portion of the impedance-matching loop and is separated from the impedance-matching loop by a gap, an outer edge comprising a top edge and a bottom edge on a y-axis of the antenna, and a left edge and a right edge on a x-axis of the antenna, and opposing ends that extend from the bottom portion to the curved inner edge. The antenna further comprises a top antenna region arranged between the top portion and the curved inner edge, a bottom antenna region arranged along the opposing ends and between the bottom edge and the curve inner edge, a left antenna region arranged to extend from the left edge to the curved inner edge, and a right antenna region arranged to extend from the right edge to the curved inner edge. In some embodiments, the top antenna region has a reduced magnetic field interaction in the y-axis, and/or the bottom antenna region has a reduced magnetic field interaction in the y-axis, and/or the left antenna region and/or the right antenna region has a reduced magnetic field interaction in the x-axis. The RFID device may be applied to the package containing a high-dielectric material directly or may be applied to a label that is attached to the package containing a high-dielectric material.

Some embodiments of a Radio Frequency Identification (RFID) device are provided herewith. The RFID device includes an antenna formed from an electrically conductive material and an impedance-matching loop operatively coupled to the antenna. The RFID device further includes an integrated circuit (IC) operatively coupled to the impedance-matching loop. The RFID device has a first and second side, and may exhibit a first directional sensitivity pattern when a first dielectric material is located within a first distance of the first side of the device. The RFID device may exhibit a second directional sensitivity pattern in a predetermined direction when the first dielectric material is located within the first distance of the first side of the device and a second dielectric material is located within a second distance of the second side of the device.

In some cases, a RFID device is provided. The RFID device may include a first line of conductive material defining a loop antenna and a slot and a second line of conductive material connected to the first line of conductive material at a first and second location. The RFID device may further includes an IC operatively connected to the first line of conductive material across the slot. The RFID device has a first and second side, and the antenna may exhibit a first directional sensitivity pattern when a first dielectric material is located within a first distance of the first side of the device. The RFID device may exhibit a second directional sensitivity pattern in a predetermined direction when the first dielectric material is located within the first distance of the first side of the device and a second dielectric material is located within a second distance of the second side of the device.

In some cases, a method of responding to RFID interrogation signals by a RFID device is provided. In the method, the RFID device may receive a first RFID interrogation signal from a RFID reader within a first directional sensitivity when a first dielectric material is located within a first distance of a first side of the RFID device. The RFID device may transmit a first RFID response signal in the first directional sensitivity, the first directional sensitivity configured to intersect with a read aperture of the RFID reader. The RFID device may receive a second RFID interrogation signal from the RFID reader within a second directional sensitivity when the first dielectric material is located within the first distance of the first side of the RFID device and a second dielectric material is located within a second distance of a second side of the RFID device. The RFID device may transmit a second RFID response signal in the second directional sensitivity in a predetermined direction, wherein the second directional sensitivity is configured to intersect with the read aperture of the RFID reader.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates a conventional RFID device.

FIG. 1B illustrates a conventional RFID device and its radiation pattern.

FIG. 1C illustrates a conventional RFID device with a modified radiation pattern.

FIG. 2 illustrates a RFID device placed on a package containing a high dielectric material according to aspects of the present disclosure.

FIGS. 3A-B illustrate a package having a RFID device according to aspects of the present disclosure.

FIGS. 3C-D illustrate stacked configurations of packages with a RFID device, according to aspects of the present disclosure.

FIG. 4A illustrates a graph of reflection coefficients for RFID devices according to aspects of the present disclosure.

FIG. 4B illustrates a graph of total radiation efficiency comparing antenna designs from Table 1 of the examples according to aspects of the present disclosure.

FIG. 5 illustrates a wide armed dipole antenna for RFID device according to aspects of the present disclosure.

FIG. 6 illustrates a wide armed dipole antenna having an top antenna region with a reduced magnetic field interaction for RFID device according to aspects of the present disclosure.

FIG. 7 illustrates a wide armed dipole antenna having an left and right antenna regions with a reduced magnetic field interaction for RFID device according to aspects of the present disclosure.

FIG. 8 illustrates a hollow dipole antenna for RFID device according to aspects of the present disclosure.

FIG. 9 illustrates a hollow dipole antenna having an top antenna region with a reduced magnetic field interaction for RFID device according to aspects of the present disclosure.

FIG. 10 illustrates a hollow dipole antenna having an left and right antenna regions with a reduced magnetic field interaction for RFID device according to aspects of the present disclosure.

FIGS. 11A-11H illustrate variations of wide armed dipole antennas for RFID devices according to according to aspects of the present disclosure.

FIG. 12 is a variation of a hollow dipole antenna for RFID devices according to according to aspects of the present disclosure.

FIG. 13 is an antenna having a non-square shape for RFID devices according to according to aspects of the present disclosure.

FIG. 14 illustrates an antenna having outside conductive elements for a RFID device according to according to aspects of the present disclosure.

FIG. 15 illustrates a RFID device incorporating a spacer according to aspects of the present disclosure.

FIGS. 16A-B illustrate RFID devices according to aspects of the present disclosure.

FIG. 17 illustrates a RFID device having an array according to aspects of the present disclosure.

FIG. 18 illustrates an asymmetrical RFID device that is attached to a package having different regions of high and low dielectric loss according to aspects of the present disclosure.

FIG. 19 is a radiation pattern graph for Examples 1-3.

FIG. 20 is a radiation pattern graph for Examples 6-9.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Radio Frequency Identification (RFID) technology has become increasingly important in various industries for tracking and managing products. However, conventional RFID tags may face challenges when used with lossy, high-dielectric materials, such as food products, liquids, or certain packaging materials. Exemplary high-dielectric materials may include proteins such as meat including but not limited to beef, chicken, turkey, pork, seafood, as well as other similar proteins. The high-electrical material is generally wrapped in a plastic film and carried on a foam tray. The relative permittivity of the plastic foam and foam tray is accounted for as part of the entire package. The RFID device may be attached to the plastic film. Without limitations, the high-dielectric materials may also include other proteins such as milk, yogurt, and eggs or egg products. The high-dielectric materials generally may have a relative permittivity (εᵣ) that is less than or equal to 60, e.g. less than or equal to 55 or less than or equal to 50. The relative permittivity (εᵣ) for high-dielectric materials should be higher than 5, e.g., preferably higher than 15 or more preferably higher than 20. The temperature of the package (frozen or thawed), moisture content, and fat percentage of the protein are all factors that can contribute to variations into the relative permittivity (εᵣ). The RFID devices described herein have improved adaptability to respond to variations across multiple types of high-dielectric materials. Accordingly, in terms of ranges, the relative permittivity (εᵣ) may be from 10 to 60, e.g., preferably from 15 to 55, preferably from 20 to 55, preferably from 25 to 55, preferably from 30 to 55, preferably from 35 to 55 or more preferably from 40 to 55. The RFID device may also be used on packages with a relative permittivity of greater than 60. These high-dielectric materials can significantly affect the performance of RFID tags by altering their resonant frequency and reducing their radiation efficiency.

The relative permittivity and loss tangent (“tan δ”) can be measured by any appropriate method using dielectric spectroscopy or resonator cavities which are commonly used dielectric analysis techniques. At ambient temperature, permittivity and dielectric losses of dielectric materials s can be considered as relatively constant in particular in the bandwidth of interest. The permittivity value of a material and also to its tan δ loss factor at a given frequency for example. Unless otherwise noted, the values indicated in this description and the claims that follow correspond to those measured at any frequency within the band of 800-1000 MHz. The measurements may be test the variation between temperature of 20° C. and freezer temperature of −18° C. In particular, the values relative permittivity and tan δ may be measured by means of a DAK-TL2 using open coaxial probes and relative permittivity and tan δ of the material under test are calculated from the reflection coefficient measured at the probe flange. In DAK-TL2, software calculates the relative permittivity and tan δ constant from the measurement on the basis of the impedance measured at the end of the open-ended coaxial probe connected to a vector network analyzer.

The present disclosure relates to environmentally adaptable RFID devices that overcomes these challenges. By adapting its characteristics based on the surrounding environment, this RFID device may maintain acceptable performance when placed on or near high-dielectric materials. As is used in the art, RFID devices may be referred to as RFID “tags,” RFID “labels” or RFID “inlays,” depending on the specific construction of the RFID device and its intended application. In any case, the disclosed embodiments are equally applicable to any of the variations implied by the different terms, and, as such, the terms are used interchangeably herein. It will be understood that the use of one term does not exclude the others from the scope of the disclosed embodiments.

In some embodiments, an environmentally adaptable RFID device may incorporate antenna designs that are configured for efficient operation across a range of dielectric conditions. These antenna designs may include features such as non-meandering antenna paths, specific impedance-matching techniques, antenna configurations, radiation pattern manipulation, or combinations thereof. The RFID device may be capable of modifying its readability, which may be a composite of sensitivity, backscatter, and radiation patterns, in response to complex dielectric and conductive environments.

In some cases, the RFID device may utilize a high initial resonance frequency in free air, which may shift to the desired operating range when placed on high-dielectric materials. This approach may allow for improved performance in challenging applications, such as tracking meat products in store coolers or identifying items packaged in materials that can attenuate or absorb RFID signals.

In some embodiments, the environmentally adaptable RFID device may provide several potential benefits, including but not limited to improved read range in stacked or cluttered scenarios, enhanced radiation efficiency, and versatility across various applications. These characteristics advantageously may make the device suitable for use in industries such as food packaging, pharmaceuticals, and manufacturing, where high-dielectric materials are commonly encountered.

In some cases, the environmentally adaptable RFID device may include various impedance-matching mechanisms to improve performance in different environments. These mechanisms may include, for example, tuning loops, reversed T-match loops, parasitic conductive elements, interdigital capacitors, and split ring resonators.

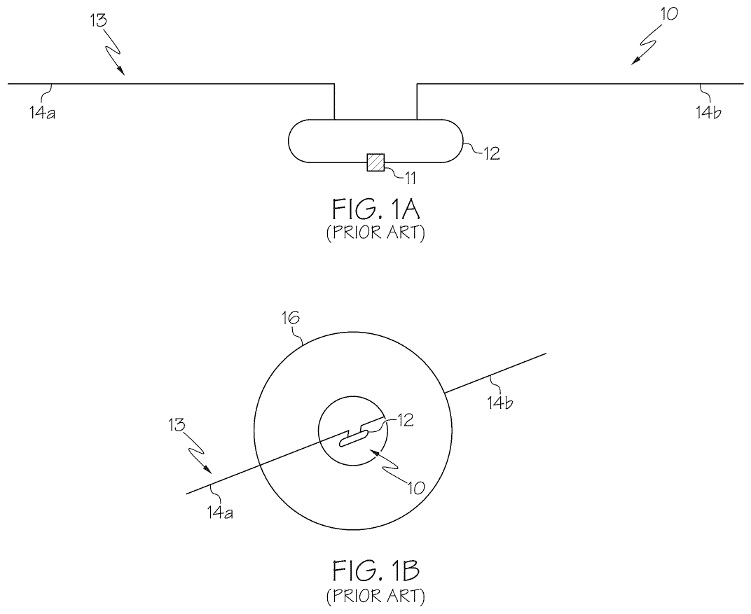

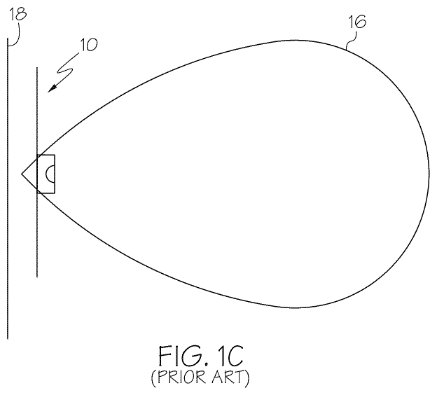

FIG. 1A illustrates a conventional RFID device 10. The RFID device 10 includes a RFID integrated circuit (IC) 11, or “chip,” which is operatively connected to a tuning and impedance-matching loop 12. The tuning and impedance-matching loop 12 may be positioned between the RFID chip 11 and the antenna 13, as shown in FIG. 1A. This particular configuration provides power transfer between the RFID chip 11 and the antenna 13. The antenna 13 of FIG. 1A is formed by two arms 14a and 14b. The dimensions of the tuning and impedance-matching loop 12 and arms 14a and 14b may be configured such that the impedance of the RFID chip 11 is transformed to be the conjugate of the antenna 13 impedance.

FIG. 1B illustrates a radiation pattern 16 associated with the conventional RFID device 10. The radiation pattern 16 may extend outward three-dimensionally (3D) from the RFID device 10 in a toroidal or donut-like shape, which may be a characteristic of many dipole antennas. This radiation pattern 16 typically exhibits minimum readability in the “end on” orientation (i.e., outward from arms 14a or 14b), and maximum readability in the “face on” direction (i.e., substantially perpendicular to the end on direction). However, the radiation pattern 16 of the conventional RFID device 10 performs poorly when placed on or near high-dielectric, lossy materials.

The embodiments described herein provide improvements over the conventional RFID device 10; in particular, the RFID devices described herein provide improved performance when placed on or near high-dielectric, lossy materials.

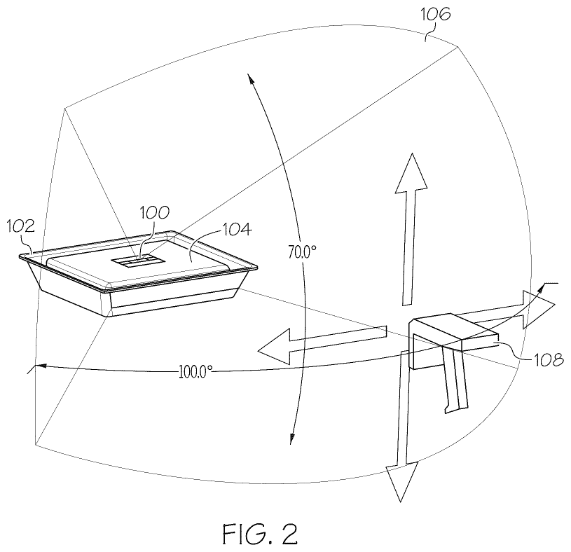

FIG. 2 illustrates a RFID system that may include a RFID device 100 positioned on a package 102 containing a lossy and high-dielectric material 104. RFID device 100 may comprise the RFID integrated circuit chip and an antenna as described further herein. The RFID device 100 may interact with a sensitivity aperture 106 of a RFID reader 108. Particularly, when an RFID reader 108 is activated, a UHF RF signal may be transmitted from the RFID reader 108. In such instances, when the RFID device 100 is influenced under the transmitted UHF RF signal, the antenna of the RFID device 100 receives and transmits back the UHF RF signal to the reader 108 with the information stored in the RFID IC chip.

In some embodiments, the information stored in the RFID IC chip may include, for example, an item identification system, an item locating system, or an item indication system. The item identification system as used herein includes item identification, item location, and item indication in one or more embodiments falling within the scope of the present subject matter.

In FIG. 2, the sensitivity aperture 106 is represented by a curved dome-like structure surrounding the package 102 and RFID device 100. For purposes of illustration, in FIG. 2 the sensitivity aperture is shown to extend 100° horizontally and 70° vertically from the RFID device 100, but it will be appreciated that other dimensions of the sensitivity aperture 106 are possible and, in some cases, desirable.

In some cases, the RFID reader 108 may be in a fixed position. In some cases, the RFID reader may be moved or moveable, as represented by the bold horizontal and vertical arrows. For purposes of discussion herein, a RFID reader 108 may be implemented as a fixed device or may be implemented as a mobile device. In some embodiments, where the relative position of a zone containing an object to which the RFID device is attached, such as a food item, the RFID reader may be fixed within the zone. A fixed RFID reader may be positioned at a point of egress to the zone to monitor devices within a sub-zone such as on a shelf, within a fridge, or within a freezer. In one embodiment, the RFID reader may be mobile, where the relative position between the RFID reader and RFID device changes over time. In the latter case, the RFID reader may be, for example, a hand-held reader or a robotic reader.

The function of a RFID device in a volume may be characterized by a number of factors; for example, the sensitivity (a function of realized gain and the minimum power incident at the device's position that will cause it to operate), an associated frequency with an associated 3D angular property (often described as a radiation pattern), or backscatter (the signal generated by the RFID device associated with a modulated change in its cross-section). All of these factors are a function of the environment in the 3D space around the RFID device, characterized as volumes of materials with different dielectric/magnetic and conductive properties at the desired operating frequency. It should be noted that these properties can also be changed by the environment such as, for example, temperature.

Turning now to FIG. 1C, intentional modification of a radiation pattern 16 of a conventional RFID device 10 has typically been performed in the art by using a metal plate 18 or a series of longer and shorter metal rods, as in a Yagi-Uda antenna. FIG. 1C depicts a modified radiation pattern 16 of the conventional RFID device 10 when positioned adjacent to a metal plate 18. In this case, the radiation pattern 16 may become asymmetrical, with the majority of the radiation directed away from the metal plate 18. However, modifications made in this way are generally fixed (i.e., the antenna is always directional under all conditions) rather than designed to create directional peaks in response to a range of different undefined materials to maximize readability. Thus, prior art approaches either add external reflectors or other conductive elements to force the radiation pattern 16 of the RFID device 10 to become directional or use an intrinsically directional design, both of which have their accompanying difficulties and detriments. As may be appreciated, such a permanently directional approach may have the same drawbacks as a permanently omnidirectional design-its inability to adapt to changing environmental conditions renders it less suitable to be read in different situations.

Unlike the conventional approaches, the disclosed RFID devices provide design(s) capable of modifying the device's readability in response to a number of complex dielectric and conductive environments, which beneficially improves the probability of the data in the RFID device being read. In some cases the readability of a device may be a composite of sensitivity, backscatter and/or radiation patterns.

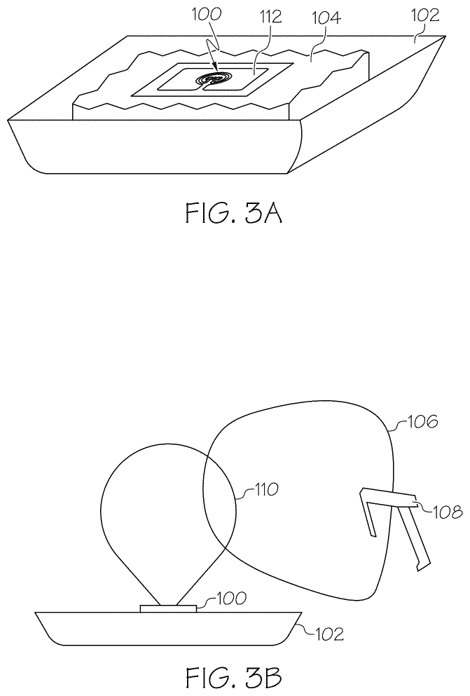

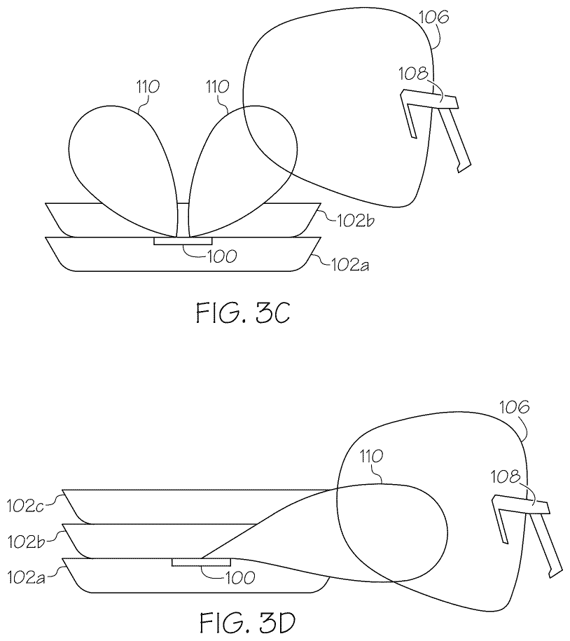

Several exemplary designs will be described in the following text and diagrams. Referring first to FIGS. 3A-D, and according to an embodiment, the adaptive radiation patterns 110 of a RFID device 100 may be designed to intersect with a sensitivity aperture 106 of a RFID reader 108. The RFID device 100 may be disposed on a label 112 or contained within a label 112. The label 112 may have at least one surface having an adhesive, preferably a pressure-sensitive adhesive or other similar adhesive. The label 112 may be adhered or otherwise affixed to a package 102 containing the high-dielectric material 104. By adapting its radiation pattern 110 in predetermined ways to intersect with the sensitivity aperture 106 of a RFID reader 108, the RFID device 100 may maintain effective communication with the RFID reader 108 across various environmental conditions.

FIG. 3A shows a RFID device 100 positioned on the top surface of a package 102 that contains a lossy and high dielectric material 104. The RFID device 100 is contained on or within the label 112 that is attached to the top surface of the package 102. Due to variations in packages, the label 112 may be placed at any point on a surface of the package 102, and in some cases, placed on a top surface or face up surface. Exemplary surfaces include the center or outer edge locations on the top surface of the package. In some embodiments, the antenna structure of the RFID device 100 provides operating range when placed on or near the lossy and high dielectric material 104. In one embodiment, the antenna structure of the environmentally adaptable RFID device 100 may be designed with a high initial resonance frequency in free air, which may shift to the desired operating range when placed on or near the lossy and high dielectric material 104. It will be appreciated that the direction for a radiation pattern 110 depends on the location of the RFID reader 108 and, for example, whether the RFID reader 108 moves relative to the package 102. In some cases, the RFID reader 108 may scan a space containing a package 100 of the lossy and high dielectric materials 104.

In FIG. 3A, the RFID device 100 is located in the center of the top of package 102. The RFID device 300 may be incorporated into a label 112, formed into the body of the package 102, or otherwise attached to the package 102. The position, size, and orientation of the RFID device 100 may be selected to complement its design and the characteristics of its radiation pattern 110 in the various environments in which the RFID device 100 is intended to operate. For example, the RFID device may be sized so it fits within an existing label's dimensions so printers and other food production equipment do not require extensive modifications, if any modifications at all, to incorporate the RFID devices 100. The RFID device 100 may be placed on a package 102 at a location that enhances the readability of the RFID device 100. In some embodiments, the RFID device 100 may be placed toward an edge or corner of a package 102 so it is more readily able to receive RFID interrogation signals from a RFID reader 108 and transmit a RFID response signals back (by being closer to open air on the side of a stack of packages 100).

FIG. 3B depicts a RFID device 100 on a single package 102, demonstrating how the radiation pattern 110 (also referred to as a “lobe of readability”) may propagate outward from the RFID device 100 in such a configuration. The radiation pattern 110 depicted in FIG. 3B is for illustrative purposes only, as any shape or size of radiation pattern 110 is consistent with embodiments disclosed herein.

In FIG. 3B, a RFID reader 108 would likely have a line-of-sight view of the RFID device 100. As noted above, the RFID device 100 may create multiple radiation patterns 110, and/or a differently shaped radiation pattern 110, in response to different environmental conditions. In one embodiment, the RFID device 100 may create at least one directional sensitivity pattern 110 configured to intersect with a read aperture 106 of a RFID reader 108. FIG. 3C illustrates a RFID device 100 positioned on a lower package 102a, on which an upper package 102b has been stacked. Typically, a second RFID device would be positioned on the upper package 102b, but for clarity, only the RFID device 100 of the lower package 102a is depicted in FIG. 3C. While not shown in FIG. 3C, each package 102a and 102b may contain a high dielectric material. It will be appreciated that when the high dielectric materials 104 are meat, e.g., chicken, pork, fish, or some other type of protein, the contents of packages 102a and 102b may not be exactly the same, even if each package 102a and 102b contains the same general type of meat. For example, each package 102a and 102b may contain a slightly different cut of protein, the protein may have a different pattern of fat, there may be slightly different amounts of protein, and so forth. Even with this in mind, the disclosed RFID device 110 should still produce a radiation pattern 110 that is likely to be read by a RFID reader 108. Put another way, the peak gain of an antenna of the RFID device 110 should be within a read aperture 106 of the RFID reader 108 even when the contents of each package 102a and 102b is not uniform. Such a radiation pattern 110 may be depicted, for example, as two lobes extending outward from the sides of the RFID device 110, parallel to the planes of packages 102a and 102b. It will be appreciated that the direction(s) in which the lobes extend in this scenario will be predetermined by the characteristics of the RFID device 100, such as, for example, the various structural elements of the antenna structure as disclosed herein.

FIG. 3D further demonstrates how a RFID device 100 may adapt its radiation pattern 110 when the RFID device 100 is positioned between multiple layers of high dielectric material. In FIG. 3D, a RFID device 100 is disposed on a lower package 102a, an upper package 102b, and a top package 102c (only the RFID device 100 of the lower package 102a is depicted in FIG. 3D for clarity). As shown, the radiation pattern 110 of the RFID device 100 of the lower package 200a may extend primarily to the side of the stacked packages 102a-c. As transmitting through multiple layers of packages 102b, 102c and associated high-dielectric materials would be difficult in some cases, if not impossible, it will be appreciated that having a radiation pattern 110 that extends to the side (i.e., toward an air gap, open region, RFID reader 108, or the like) may allow for effective signal transmission even when the RFID device 100 is sandwiched between such high-dielectric materials.

To overcome the challenges associated with high-dielectric materials, the environmentally adaptable RFID device may incorporate design features that allow for improved performance in high-dielectric environments. A number of factors have been found to improve the performance of the environmentally adaptable RFID device in multiple environments and may create environmentally dependent directional properties.

For example, in some embodiments, the improved performance may result from designing an antenna structure whose radiating elements bring a high resonance frequency in free air above the assigned operational frequency band for RFID in the country or region associated with the application. For example, the operational frequency band could be 902-928 MHz in the USA, 865-868 MHz in some parts of Europe, and 860-930 MHz according to the GS1 “Gen2” air interface protocol. Using an initial high frequency ensures that when the environmentally adaptable RFID device is placed proximate to a high-dielectric material, it falls into the desired operating frequency range. In other words, the dielectric loading effect may lower the resonance to the desired operating range.

At resonance, the current distribution of a half-wave dipole along the antenna's length forms a standing wave with a maximum at the center and a minimum at the ends. This distribution provides for efficient radiation, as it increases the antenna's effective area and the strength of the electromagnetic field it generates. In addition, the voltage and current at the feed point are in phase, further contributing to efficient power transfer and radiation.

Balancing radiation efficiency and impedance-matching—both of which are desirable characteristics—presents a challenge: a larger antenna footprint improves radiation efficiency, while a smaller dipole ensures better impedance-matching.

Antenna radiation efficiency can also be expressed as:

$${η}_{r} = {P}_{rad} / {P}_{in}$$

where:
P_{rad} is the radiated power by the antenna; and
Pᵢₙ is the input power supplied to the antenna.

Antenna total efficiency can also be expressed as:

$${η}_{t} = {P}_{rad} / {P}_{incidental}$$

where:
P_{rad} is the radiated power by the antenna; and
P_{incidental} is the incidental power supplied to the antenna.

For purposes of the present disclosure, the total efficiency and radiation efficiency were measured on a model of a double stacked chicken. The RFID devices were placed in the center of two chicken packages. Each package of chicken was on a foam tray and wrapped in a polyamide film. The foam tray had a thickness of 4.5 mm and a relative permittivity εr=1.1, loss δ=0.046. The polyamide film had a thickness of 0.02 mm and a relative permittivity εr=4.3, loss δ=0.004. The chicken had a dimension of 380 mm×225 mm with a thickness of 40 mm. The relative permittivity of the chicken was εr=56.8, loss δ=0.38.

In one embodiment, to achieve this high initial resonance, an antenna of the environmentally adaptable RFID device may use a non-meandering geometry, which minimizes its electrical length while maintaining the necessary length for efficient radiation. In the context used herein, “non-meandering” refers to an antenna structure of the RFID device that has at least one external edge that is substantially straight or curved. In some embodiments, each of the external edges may be non-meandering. In one embodiment, the antenna configuration may have at least one external edge that is meandering, which is characterized by a back-and-forth antenna pattern.

In one embodiment, a non-meandering antenna may be employed to avoid areas of high current density, which would occur at the tight bends characteristic of a meandering antenna and decrease the antenna's radiation efficiency. While, as will be discussed below, non-meandering antennas may come in different shapes and may have some bends, notches, channels, etc., formed therein, the overall design of a non-meandering antenna will have a reduced number of such bends or bends having a reduced height. When such bends occur, they may be formed to reduce the current density such as, for example, being at an obtuse angle or rounded. In some embodiments, for example, 90° bends may be avoided, while in other embodiments, sharp bends may be used. A meandering conductive trace forces currents to flow in opposite directions in tightly-spaced segments, which causes their electromagnetic fields to partially cancel each other out, thus reducing the power radiated. Furthermore, this proximity effect induces eddy currents that increase the wire's resistance, converting more of the input power into wasted heat instead of radio waves.

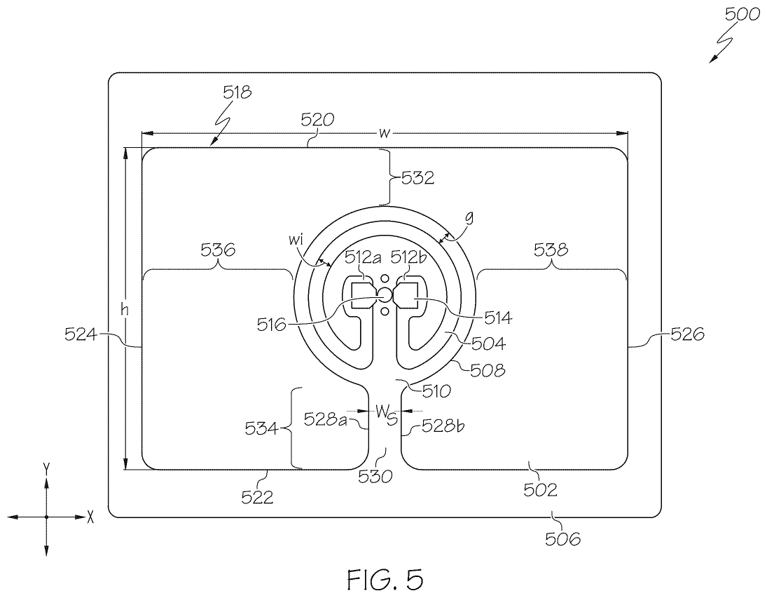

In some cases, a non-meandering antenna may have a slot in which an inductive impedance-matching loop is located without affecting the overall non-meandering nature of the antenna. In some cases, other deviations to the edges of such an antenna do not need to be entirely absent to remain non-meandering as used herein. For example, notches, slots, and the like may be formed in a non-meandering antenna without affecting its overall non-meandering nature. A non-exhaustive overview of such modified non-meandering antennas is illustrated in, for example, FIGS. 5-18. In various embodiments discussed herein, a non-meandering antenna may be in the form of a loop antenna. The above-referenced deviations to the non-meandering antenna may be used in such a loop antenna to manipulate the current flow around the perimeter of the loop to affect the antenna's performance in desired ways.

In addition, various embodiments contemplate that an environmentally adaptable RFID device may have dimensions selected such that when the antenna interacts with high-dielectric materials, its resonance shifts down into the appropriate frequency band. As a result, an antenna designed for use with high-dielectric materials may be shorter than one designed for operation in free air. However, both the smaller size and the dielectric losses may reduce radiation resistance and efficiency.

According to some embodiments, an antenna design for an environmentally adaptable RFID device that will be used with high-dielectric materials involves a balance of electrical length and physical size. While a shorter electrical length may be desirable for achieving the necessary high resonance frequency, a larger physical size- and therefore a greater surface area-typically increases radiation resistance. This increased resistance enhances the antenna's radiation efficiency, boosting its performance when applied to high-dielectric materials. However, it has been found that the antenna's size may also need to be defined to fit within the constraints of the primary or secondary label, as in the case of protein tagging. In addition, increasing the size of an antenna will eventually result in a decrease of the antenna's resonance frequency.

In some embodiments, the antenna may have a size that achieves enhanced total efficiency and/or radiation efficiency. Although larger antennas with greater perimeters may be used in some embodiments, the size of the antenna may be conformed to fit within a label. In one embodiment, the antenna may have a perimeter that ranges from 130 mm to 170 mm, e.g., ranges from 135 mm to 165 mm, from 140 mm to 165 mm, or ranges from 145 mm to 160 mm. The perimeter is determined by measuring the outer edge of the antenna. In one embodiment, the height may range from 21 mm to 50 mm, e.g., range from 25 mm to 45 mm or range from 25 mm to 35 mm. To avoid problems with impedance loop, the minimum height may preferably be greater than or equal to 21 mm, e.g., greater than or equal to 23, greater than or equal to 25, or greater than or equal to 27. In some embodiments, the length of the width may be greater than the length of the height. Accordingly, the width may range from 40 mm to 70 mm, e.g., from 44 mm to 60 mm or from 44 mm to 52 mm. Using the width and height of the antenna, an aspect ratio may be determined that is associated with high performing antennas. In one embodiment, the aspect ratio (width to height) may be greater than or equal to 1.2, e.g., greater than 1.25, greater than 1.5, greater than 1.9 or greater than 2.0. In terms of ranges, the aspect ratio may be from 1.2 to 2.8, e.g., from 1.25 to 2.7, from 1.5 to 2.6 or from 1.9 to 2.5.

The differences in efficiency and frequency response among these antenna designs demonstrate how various configurations of the antenna structure may affect the performance of an environmentally adaptable RFID device in different environments. By improving the antenna design, the environmentally adaptable RFID device may maintain effective operation across a range of challenging conditions, such as when placed on or near a lossy, high dielectric material.

In addition, low capacitance and high inductance drives a response from the antenna that is primarily magnetic, rather than electrical, in nature. In other words, creating an electric field maximum that is as small as possible (given the relevant design constraints) has been found to cause most of the energy of the antenna to be directed toward generating a magnetic field. This is significant because a magnetic field can more effectively pass through high-dielectric materials than an electrical field, which tends to be absorbed or otherwise impeded.

Turning now to FIG. 5, there is provided a RFID device 500 comprising an antenna 502 and impedance-matching loop 504. RFID device 500 may be adhered or otherwise affixed to a label 506. The label 506 may be applied to the package containing the high-dielectric material. In some embodiments, the RFID device 500 may be directly applied to the package without using a label 506. In some embodiments, the antenna 502 may create at least one directional sensitivity pattern configured to intersect with a read aperture of a RFID reader. The antenna 502 improves the read rate of the RFID device 500 when the RFID device is placed on packages containing high dielectric materials.

In some cases, antenna 502 may be a wide arm dipole antenna. In some embodiments, wide arm dipole antennas may have a solid construction with less than 20% of the area open, e.g., less than 15% of the area open. A solid antenna configuration has been found to strike a desirable balance between the electrical length and physical size of a RFID device 500. The wide arm dipole antennas may also achieve a high resonance frequency in free air while maintaining strong radiation efficiency when applied to high-permittivity protein products.

In some embodiments, RFID device 500 has an antenna 502 surrounding at least a portion of the impedance-matching loop 504. In some embodiments, the antenna 502 may be formed from an electrically conductive material, such as copper, aluminum, silver, and including alloys thereof as well as conductive inks. In some embodiments, a single sheet of metal such as, for example, aluminum sheet or foil may be cut to form the antenna described herein. The metal sheet may be cut using for example any conventional antenna cutting methods or techniques such as die cutting, laser cutting, etching and so forth.

The gap (g) between the antenna 502 and impedance-matching loop 504 may be in the range from 0.3 mm to 3 mm, e.g., from 0.4 mm to 2.5 mm or from 0.5 mm to 2.0 mm. Accordingly, the antenna 502 may define a curved inner edge 508 that forms an aperture 510 to surround at least a portion of the impedance-matching loop 504. In some embodiments, the aperture 510 has a maximum diameter (d) from 10 mm to 30 mm, e.g., from 12 mm to 26 mm or from 14 mm to 24 mm.

Impedance-matching loop 504 comprises ends 512a, 512b that terminate within the impedance-matching loop 504. Impedance-matching loop 504 has a line width (wᵢ) that may be between 0.3 mm and 3 mm, e.g., between 0.4 mm and 2.5 mm or between 0.5 mm and 2.0 mm. The RFID device 500 may have one or more straps 514 connecting the ends 512a, 512b to an integrated circuit (IC) chip 516. In some embodiments, the IC chip 516 may be a UHF RFID chip.

The curvature of the curved inner edge 508 may correspond to the curvature of the impedance-matching loop 504. In addition, the aperture 510 may be defined by the curvature of the curved inner edge 508. The impedance-matching loop 504 may have a circular configuration, oval configuration, oblong configuration, rounded configuration, triangular configuration, rectangular configuration, or other similar configurations. Accordingly, the curved inner edge 506 may have a corresponding shape.

Antenna 502 also has an outer edge 518 comprising a top edge 520, bottom edge 522, left edge 524 and right edge 526. Generally speaking, the terms “top”, “bottom”, “left”, and “right” are relative and are used to orient the outer edges without limiting the device to a particular orientation. The top edge 520 and bottom edge 522 are positioned in line with the y-axis. In some embodiments, the top edge 520 may be non-meandering. Although it is preferred that the top edge 520 may be non-meandering, the other edges of the outer edge 518 may also be non-meandering. In some embodiments, there may be one or more meanders in the outer edge 518, including the top edge 520 or bottom edge 522.

The left edge 524 and right edge 526 are positioned in line with the x-axis. In one embodiment, the top edge 520 has a width (w) that may be from 40 mm to 70 mm, e.g., from 44 mm to 60 mm or from 44 mm to 52 mm. The bottom edge 522 may have a similar width as the top edge 520. The left edge 524 and right edge 526 may each independently have a height (h) from 21 mm to 50 mm, e.g., from 25 mm to 45 mm or from 25 mm to 35 mm. Preferably, the height of each of the left edge 524 and right edge 526 may be similar. The left edge 524 and right edge 526 may be adjoined to the top edge 520 by a rounded corner or square corner.

The aspect ratio of the antenna 502 may be calculated by dividing width (w) by height (h). In one embodiment, the aspect ratio of the antenna 502 may be greater than or equal to 1.45, e.g., greater than 1.5, greater than 1.7, greater than 1.9 or greater than 2.0. In terms of ranges, the aspect ratio may be from 1.45 to 2.8, e.g., from 1.5 to 2.7, from 1.7 to 2.6 or from 1.9 to 2.5.

Opposing ends 528a, 528b extend from the bottom edge 522 to the aperture 510 to form a slot 530. The opposing ends 528a, 528b may be adjoined to the bottom edge 522 by a rounded corner or square corner. In some embodiments, the width (wₛ) of the slot 530 may range from 0.3 mm to 3 mm, e.g., from 0.4 mm to 2.5 mm or from 0.5 mm to 2 mm. In one embodiment, the slot 530 may have a uniform width which accordingly aligns the opposing ends 528a, 528b in a parallel configuration. However, while a uniform width may be useful for the antenna structure, other embodiments as disclosed herein may have a non-parallel slot having curvatures. The angular length of the slot 530 between the impedance-matching loop 504 and the antenna 502 may typically be between 15° and 330°. The left edge 524 and right edge 526 may be adjoined to the bottom edge 522 by a rounded corner or square corner.

The perimeter of the antenna 502 may be measured by adding the length of each of the edges, including the opposing ends. In one embodiment, the perimeter of the antenna 502 may be from 130 mm to 160 mm, e.g., from 135 mm to 155 mm, from 140 mm to 150 mm.

In some embodiments, the curved inner edge 506 of the antenna 502 and impedance-matching loop 504 may be operatively coupled despite not being physically connected. Instead, electric and magnetic fields couple the two components. The electric field, concentrated in the gap (g) between the impedance-matching loop 504 and antenna 502, interacts with the dielectric properties of the high-loss material, altering the impedance match between the IC chip 510 and the antenna 502. The nature of this coupling may be dependent on a number of factors including but not limited to the maximum diameter of the aperture 510, gap (g) between the antenna 502 and impedance-matching loop 504, line width (wᵢ) of the impedance-matching loop 504, slot width (wₛ), and/or angular length of the slot 530.

The antenna 502 comprises at least four regions that may be adjusted to reduce the magnetic field interaction and thereby improve the antenna performance when adhered to a package containing a high-dielectric material. Two of the regions are positioned in line with the y-axis and two of the regions are positioned in line with the x-axis. It should be understood that these regions are not exclusive and may have overlapping portions. A top antenna region 532 may be provided between the top edge 520 and curved inner edge 508. In one embodiment, the top antenna region 532 may be positioned in line with the y-axis. Also positioned in line with the y-axis there may be a bottom antenna region 534. The bottom antenna region 534 may be arranged between the bottom edge 522 and the curved inner edge 508. In one embodiment, the bottom antenna region 534 may be arranged along the opposing ends 528a, 528b. Along the x-axis, there is provided a left antenna region 536 arranged between the left edge 524 and curved inner edge 508, and a right antenna region 538 arranged between the right edge 526 and curved inner edge 508.

To achieve improvements in the antenna performance the embodiments disclosed herein adjust at least one of these antenna regions to have a reduced magnetic field interaction. In one embodiment, at least two of these regions may be adjusted to achieve a desirable reduced magnetic field interaction.

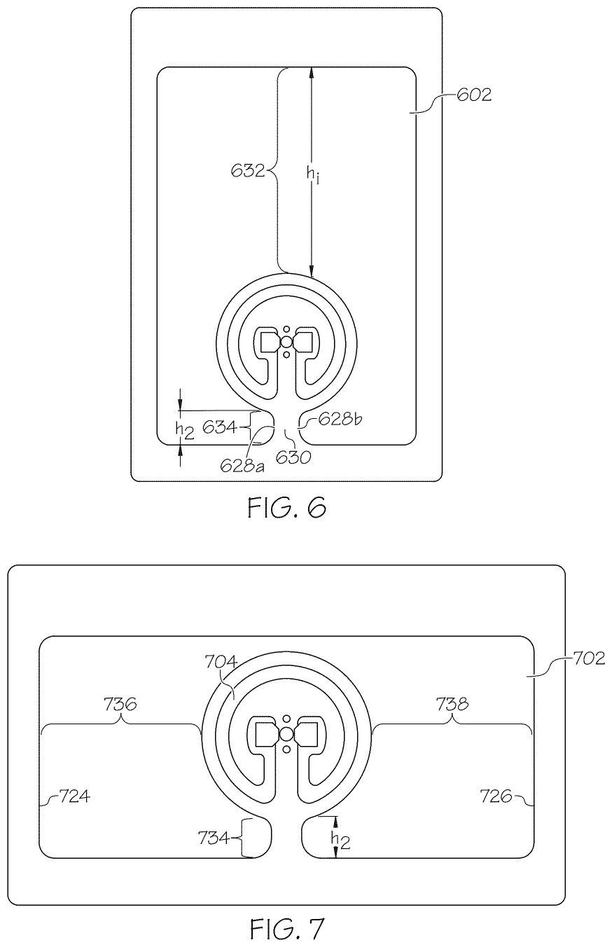

FIG. 6 shows an antenna 602 having an adjustment in the top antenna region 632 to achieve a reduced magnetic field interaction. As shown in FIG. 6, the gap top height (h1) of the top antenna region 632 may be larger than the gap bottom height (h2). Accordingly, the antenna 602 may be asymmetrical in the y-axis. Based on relationship, the gap top height (h1) may be at least three times larger than the gap bottom height (h2). Accordingly, the top antenna region 632 may be larger than the bottom antenna region 634. In addition, to reducing the magnetic field interaction in the top antenna region 632, this adjustment may also reduce the magnetic field interaction in the bottom antenna region 634. In particular, the magnetic field interaction between the opposing ends 628a, 628b along the slot 630 may be reduced. For example, when the height of the antenna is 30 mm and the aperture diameter is 10 mm, the gap top height (h1) may be greater than or equal to 15 mm and a gap bottom height (h2) of less than 5 mm. Other values may be determined for variations in the antenna height and aperture diameter. In one embodiment, by adjusting the bottom antenna region 634 to be preferably less than 6 mm, e.g., less than 5.5 mm or less than 5 mm, the antenna performance may be improved by reducing magnetic field interaction in the top antenna region and/or bottom antenna region. This is associated with improvements in the total efficiency and radiation efficiency. Such improvements provide for improve readability when the RFID device 600 is placed on packages containing high-dielectric materials.

Although FIG. 6 has reduced magnetic field interaction in the top antenna region 632 and bottom antenna region 634, in some embodiments the reduced magnetic field interaction may be either in the top antenna region 632 or bottom antenna region 634. In some embodiments, the reduced magnetic field interaction may also be adjusted in the left antenna region and/or the right antenna region.

FIG. 7 shows an antenna 702 having an adjustment in the left antenna region 736 and the right antenna region 738 to achieve a reduced magnetic field interaction. In one embodiment, the antenna 702 may have symmetry in the x-axis and the left antenna region 736 and the right antenna region 738 may be similarly sized. In such configurations, the impedance-matching loop 704 may be located in the center or near the center of the antenna 702 with respect to the x-axis. In one embodiment, the reduced magnetic field interaction may be achieved by using an antenna 702 having a higher aspect ratio. In one embodiment, the aspect ratio may be greater than 2.1, e.g., greater than 2.3 or greater than 2.4. In terms of ranges, the aspect ratio may be from 2.1 to 2.9, e.g., from 2.3 to 2.8 or from 2.4 to 2.6. A higher aspect ratio increases the size of the left antenna region 736 and right antenna region 738 which has been shown to reduce magnetic field interaction. FIG. 7 also has a reduced magnetic field interaction in the bottom antenna region 734 due to the gap bottom height (h2) being reduced, i.e. is less than 6 mm.

In some embodiments, the antenna shown in FIG. 7 may be asymmetrical antenna in the x-axis, thus adjusting the relative size of the left antenna region 736 and right antenna region 738. The left antenna region 736 and the right antenna region 738 may also be adjusted by positioning the impedance-matching loop 704 away from the center. When the impedance-matching loop 704 is moved nearer to the left edge 724, the right antenna region 738 may be increased without having to adjust the aspect ratio. A similar effect may be noted in moving the impedance-matching loop 704 towards the right edge 726 for the left antenna region 736.

Although FIG. 7 has a reduced magnetic field interaction in the left antenna region 736, the right antenna region 738, and bottom antenna region 734, in some embodiments the reduced magnetic field interaction may be adjusted for the left antenna region 736, the right antenna region 738, or bottom antenna region 734. In some embodiments, the reduced magnetic field interaction may also be adjusted in the top antenna region.

FIGS. 5-7 illustrate various embodiments of the wide arm dipole antennas. In some embodiments, the RFID devices described herein may comprise a hollow dipole antenna shown in FIGS. 8-10. A hollow dipole antenna may have an open area of the antenna that is greater than 20%, and more preferably greater than 80% or even greater than 90%. Accordingly, hollow dipole antennas may be substantially devoid of conducting material. In such a configuration, the outer edge may be a conductive material that forms the antenna. This outer edge may be referred to as an antenna trace.

Turning now to FIG. 8, RFID device 800 comprises an antenna 802 and impedance-matching loop 804, where the impedance-matching loop 804 may be operatively coupled to the antenna 802. RFID device 800 may be adhered or otherwise affixed to a label 806. The label 806 may be applied to the package containing the high-dielectric material. In some embodiments, the RFID device 800 may be directly applied to the package without using a label 806. As shown in FIG. 8, the hollow dipole antenna 802 comprises an antenna trace 810 that extends along the outer edge 812 of the antenna 802 and the inner curved edge 814. In one embodiment, the antenna trace 810 may be continuous from the outer edge 812 to the inner curved edge 814. The antenna trace 810 may have a width that ranges from 0.3 mm to 3 mm, e.g., from 0.4 mm to 2.5 mm or from 0.5 mm to 2 mm. Preferably, the width of the antenna trace 810 may be uniform. In some embodiments as described herein, one edge of the antenna trace 810 may have a different width. In one embodiment, the trace width of the antenna trace 810 may be around 1 mm. This may result in an improvement of the RFID device's 800 edge-on performance as compared to, for example, a non-hollow antenna structure, which would exhibit a radiation pattern that is more face-on in direction.

In one embodiment, the antenna 802 may create at least one directional sensitivity pattern configured to intersect with a read aperture of a RFID reader. The antenna 802 improves the read rate of the RFID device 800 when the RFID device is placed on packages containing high dielectric materials.

An antenna 802 that defines an open area with the antenna trace 810 may reduce the amount of conductive material in contact with the high-dielectric material, minimizing the dielectric loading effect and helping to maintain the desired resonant frequency while reducing losses. Reducing the amount of conductive material may also have other benefits. For example, a reduced amount of conductive material may reduce the interaction the RFID device 800 may have with metal detector systems found in food processing facilities. In another example, the reduced metal content of a RFID device 800 that is attached to a package (or is part of a label that is attached to a package) may have beneficial effects when the package is recycled, as there will be less conductive material to be separated from other recyclable materials.

In some embodiments, the antenna 802 surrounds at least a portion of the impedance-matching loop 804. More preferably, the antenna trace 810 may define a curved inner edge 814 that forms an aperture 816 to surround at least a portion of the impedance-matching loop 804. The gap (g) between the antenna trace 810 and impedance-matching loop 804 may be in the range from 0.3 mm to 3 mm, e.g., from 0.4 mm to 2.5 mm or from 0.5 mm to 2.0 mm. The aperture 816 formed by the antenna trace 810 may have a maximum diameter (d) from 10 mm to 30 mm, e.g., from 12 mm to 26 mm or from 14 mm to 24 mm. Impedance-matching loop 804 comprises ends 818a, 818b that terminate within the impedance-matching loop 804. Impedance-matching loop 804 has a line width (wᵢ) that may be between 0.3 mm and 3 mm, e.g., between 0.4 mm and 2.5 mm or between 0.5 mm and 2.0 mm. In one embodiment the line width of impedance-matching loop 804 may be different from the width of the antenna trace 810. The RFID device 800 may have one or more straps 820 connecting the ends 818a, 818b to an integrated circuit (IC) chip 822.

Antenna trace 816 comprises a top edge 824, bottom edge 826, left edge 828 and right edge 830. The top edge 824 and bottom edge 826 are positioned in line with the y-axis. The left edge 828 and right edge 830 are positioned in line with the x-axis. In one embodiment, the top edge 824 has a width (w) that may be from 40 mm to 70 mm, e.g., from 44 mm to 60 mm or from 44 mm to 52 mm. The left edge 828 and right edge 830 may each have a height (h) from 21 mm to 50 mm, e.g., from 25 mm to 45 mm or from 25 mm to 35 mm. Preferably, the height of each of the left edge 828 and right edge 830 may be similar. The left edge 828 and right edge 830 may be adjoined to the top edge 824 by a rounded corner or square corner.

The aspect ratio of the antenna 802 may be calculated by dividing width (w) by height (h). In some embodiments, the aspect ratio of the antenna 802 may be greater than or equal to 1.2, e.g., greater than 1.25, greater than 1.4, greater than 1.5 or greater than 1.6. In terms of ranges, the aspect ratio may be from 1.2 to 2.2, e.g., from 1.25 to 2.1, from 1.4 to 2 or from 1.5 to 1.8.

The perimeter of the antenna 802 may be the length of the conductive trace 810, which may include the inner curved edge 814. In one embodiment, the perimeter of the antenna 802 may be from 140 mm to 170 mm, e.g., from 145 mm to 165 mm, or from 150 mm to 160 mm.

In some embodiments, the antenna trace 810 comprises opposing ends 832a, 832b that extend from the bottom edge 826 to the aperture 816. The separation of the opposing ends 832a, 832b may define a slot 834. In some embodiments, the width (wₛ) of the slot 834 may range from 0.3 mm to 3 mm, e.g., from 0.4 mm to 2.5 mm or from 0.5 mm to 2 mm. In one embodiment, the slot 834 may have a uniform width which thereby aligns opposing ends 832a, 832b in a parallel manner. In other embodiments, the slot 834 may be non-parallel and have curvatures. The angular length of the slot 834 between the impedance-matching loop 804 and the antenna 802 may typically be between 15° and 330°.

In some embodiments, the curved inner edge 814 of the antenna trace 810 and impedance-matching loop 804 are not physically connected. Instead, electric and magnetic fields couple the two components. The electric field, concentrated in the gap g between the impedance-matching loop 804 and antenna trace 810, interacts with the dielectric properties of the high-loss material, altering the impedance match between the IC chip 822 and the antenna 802. The nature of this coupling may be dependent on a number of factors including but not limited to the maximum diameter (d) of the aperture 816, gap (g) between the antenna trace 810 and impedance-matching loop 804, line width (wᵢ) of the impedance-matching loop 804, slot width (wₛ), and/or angular length of the slot 834.

The antenna 802 comprises at least four regions that may be adjusted to reduce the magnetic field interaction and thereby improve the antenna performance when adhered to a package containing a high-dielectric material. Two of the regions are positioned in line with the y-axis and two of the regions are position in line with the x-axis. In the hollow dipole antenna 802, the regions may include the open space as well as the conductive trace. Accordingly, the hollow dipole antenna shown in FIG. 8 may comprise regions having both the open space and the antenna trace. A top antenna region 836 may be provided between the top edge 824 and curved inner edge 814. In some embodiments, the top antenna region 836 may be positioned in line with the y-axis. Also positioned in line with the y-axis there may be a bottom antenna region 838. The bottom antenna region 838 may be arranged between the bottom edge 826 and the curved inner edge 814. In one embodiment, the bottom antenna region 838 may be arranged along the opposing ends 832a, 832b. Along the x-axis, there is provided a left antenna 840 arranged between the left edge 828 and curved inner edge 814, and a right antenna region 842 arranged between the right edge 830 and curved inner edge 814.

In some cases, to achieve improvements in the antenna performance the embodiments disclosed herein adjust at least one of these antenna regions to have a reduced magnetic field interaction. In some embodiments, at least two of these regions of the hollow dipole antenna may be adjusted to achieve a desirable reduced magnetic field interaction.

FIG. 9 shows an antenna 902 having an adjustment in the top antenna region 936 to achieve a reduced magnetic field interaction. As shown in FIG. 9, the gap top height (h1) of the top antenna region 936 may be larger than the gap bottom height (h2). Accordingly, the antenna 902 may be non-symmetrical. Based on relationship, the gap top height (h1) may be at least three times larger than the gap bottom height (h2). In one embodiment, the relationship between the gap top height (h1) may be at least four times larger than the gap bottom height (h2). Accordingly, the top antenna region 936 may be larger than the bottom antenna region 938. In addition, to reducing the magnetic field interaction in the top antenna region 936, this adjustment may also reduce the magnetic field interaction in the bottom antenna region 938. In particular, the magnetic field interaction between the opposing ends 932a, 932b along the slot 934 may be reduced. For example, when the height of the antenna is 30 mm and the aperture diameter is 10 mm, the gap top height (h1) may be greater than or equal to 16 mm and a gap bottom height (h2) of less than 4 mm. Other values may be determined for variations in the antenna height and aperture diameter. In one embodiment, when the bottom antenna region 938 may preferably be less than 6 mm, e.g., less than 5.5 mm, less than 5 mm, less than 4.5 mm, less than 4 mm or less than 3.5 mm, the antenna performance may be improved by reducing magnetic field interaction in the bottom antenna region.

Although FIG. 9 has reduced magnetic field interaction in the top antenna region 936 and bottom antenna region 938, in some embodiments, the reduced magnetic field interaction may be either in the top antenna region 936 or bottom antenna region 938. In some embodiments, the reduced magnetic field interaction may also be adjusted in the left antenna region and/or the right antenna region.

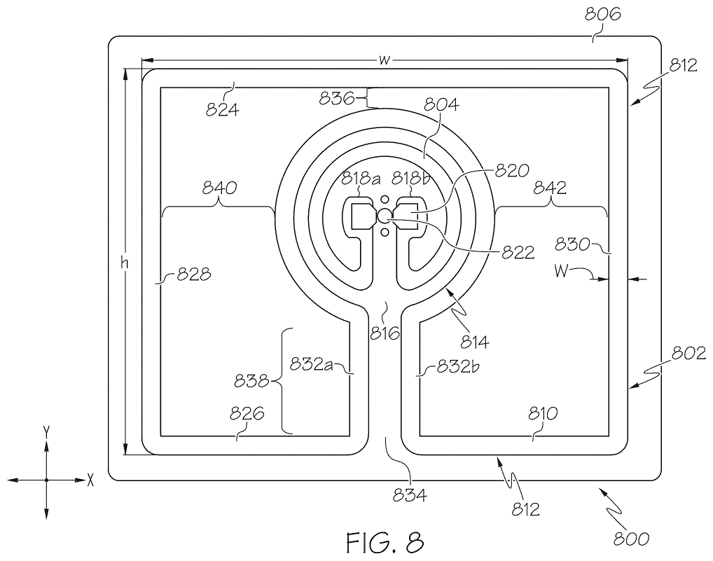

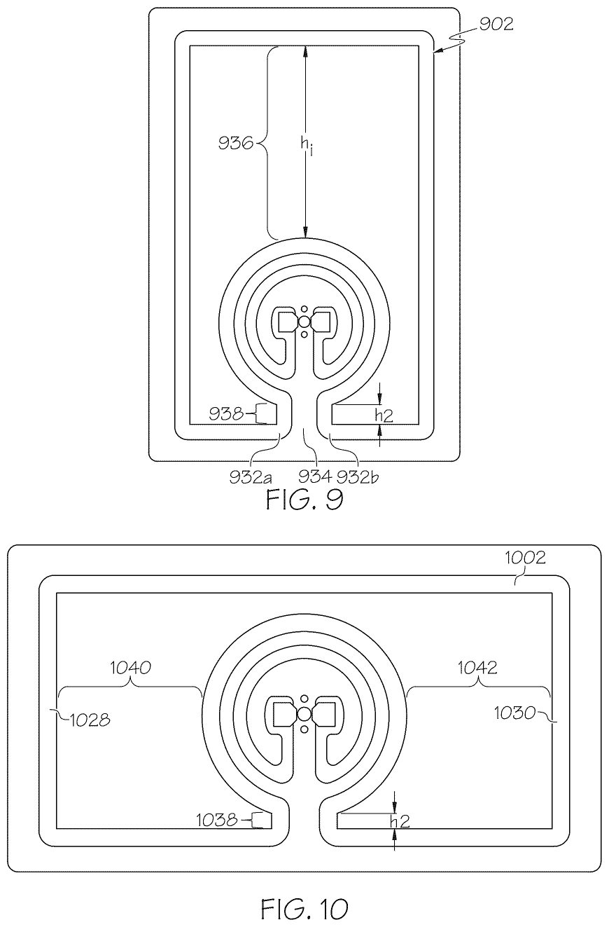

FIG. 10 shows a hollow dipole antenna 1002 having an adjustment in the left antenna region 1040 and the right antenna region 1042 to achieve a reduced magnetic field interaction. In some embodiments, the antenna 1002 may have symmetry in the x-axis and the left antenna region 1040 and the right antenna region 1042 may be similar sized. In such configurations, the impedance-matching loop 1004 may be located in the center or near the center of the antenna 1002 with respect to the x-axis. In one embodiment, the reduced magnetic field interaction for the hollow antenna 1002 may be achieved by using an antenna 1002 having a higher aspect ratio. In one embodiment, the aspect ratio may be greater than 1.6, e.g., greater than 1.8 or greater than 2. In terms of ranges, the aspect ratio may be from 1.6 to 2.4, e.g., from 1.8 to 2.2 or from 2 to 2.15. A higher aspect ratio increases the size of the left antenna region 1040 and right antenna region 1042 which has been shown to reduced magnetic field interaction. FIG. 10 also has a reduced magnetic field interaction in the bottom antenna region 1038 due to the gap bottom height (h2) being reduced.

The left antenna region 1040 and the right antenna region 1042 may also be adjusted by positioning the impedance-matching loop 1004 away from the center. When the impedance-matching loop 1004 is moved nearer to the left edge 1028, the right antenna region 1042 may be increased without having to adjust the aspect ratio. A similar effect may be noted in moving the impedance-matching loop 1004 towards the right edge 1030 for the left antenna region 1040.

Although FIG. 10 has reduced magnetic field interaction in the left antenna region 1040, the right antenna region 1042, and bottom antenna region 1038, in some embodiments the reduced magnetic field interaction may be adjusted for the left antenna region the left antenna region 1040, the right antenna region 1042, or bottom antenna region 1038. In some embodiments, the reduced magnetic field interaction may also be adjusted in the top antenna region.

The antenna structures shown in FIGS. 5-10 are exemplary of antenna devices for use in RFID device placed on or near high-dielectric materials. Additional variations are discussed further herein and these variations may be combined to achieve high performing antenna structures in different configurations.

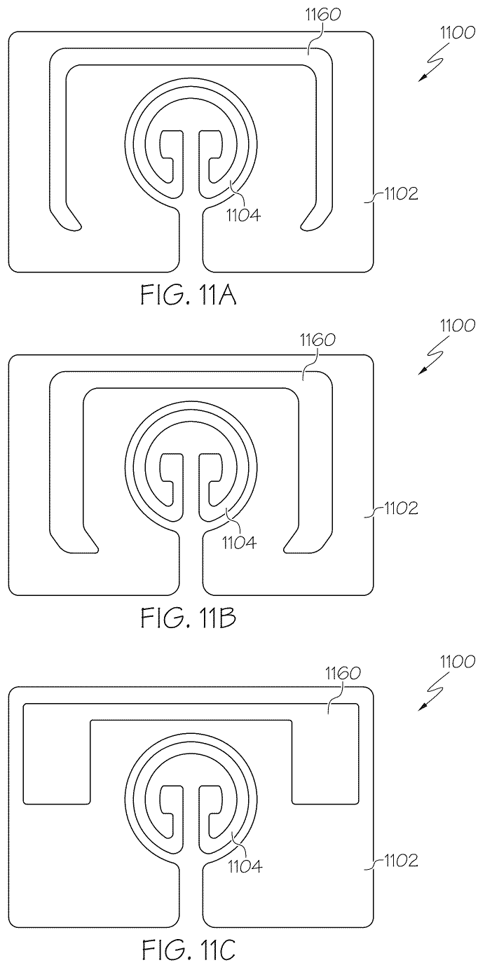

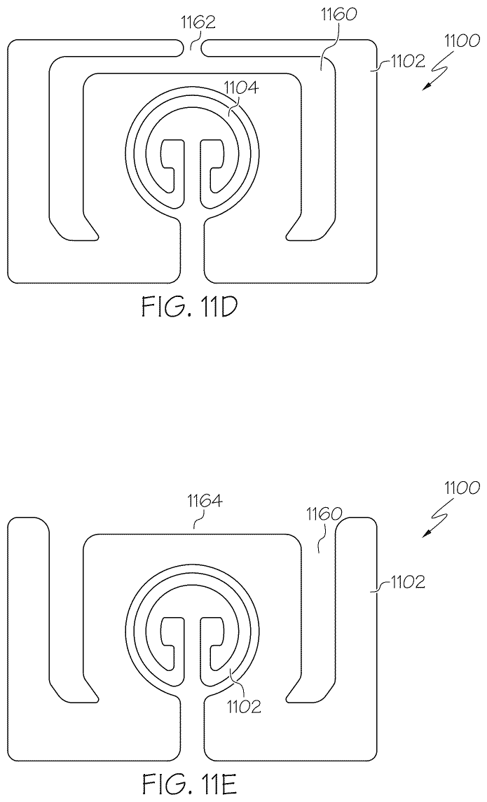

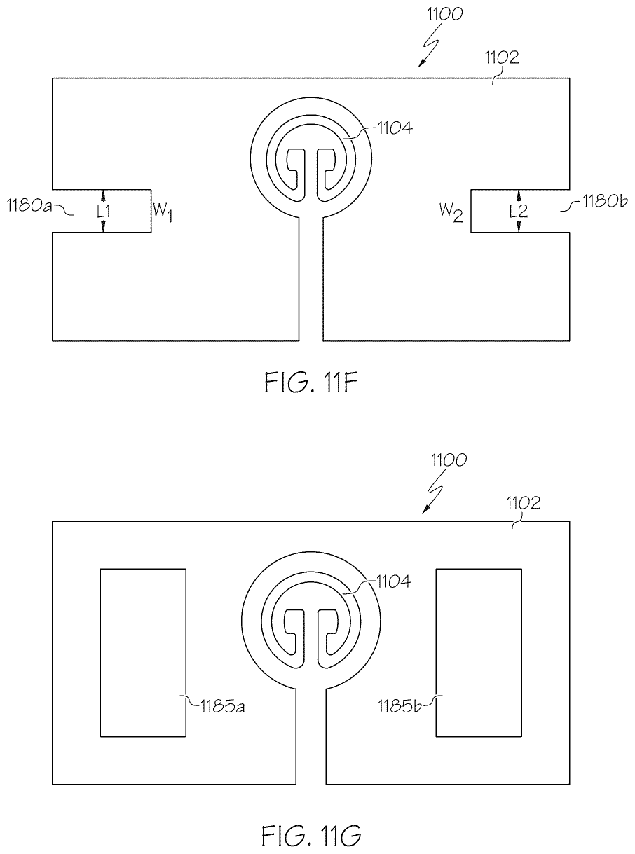

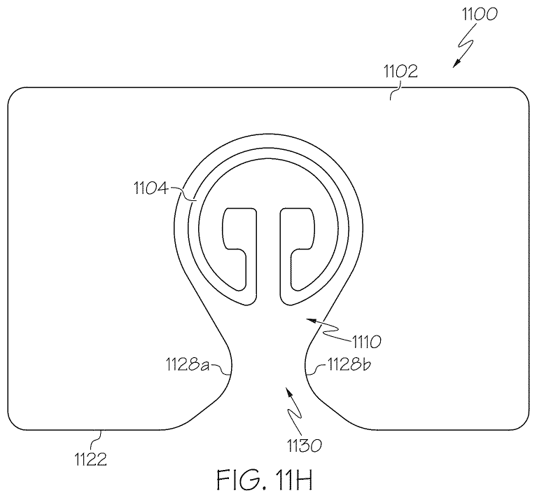

Turning to FIGS. 11A-11H, illustrate various wide-arm dipole antennas as described in FIG. 5 with an open area 1160. As in FIG. 5, the RFID device 1100 comprises an antenna 1102 surrounding an impedance-matching loop 1104. The impedance-matching loop 1104 is shown without the strap and/or IC chip for clarity purposes. The antenna 1102 and impedance-matching loop 1104 do not physical touch, but use electric and magnetic fields coupling. The presence of the gap 1160 in the antenna 1102 does not cause a delirious effect on the antenna performance. The shape and size of the open area 1160 is not limiting and the examples shown in FIGS. 11A-11H are illustrative.

FIGS. 11A-11h illustrate various shapes of the open area 1160 formed within an antenna structure 1102 of a RFID device 1100, in accordance with an embodiment. The RFID devices 1100 depicted in FIGS. 11A-11H demonstrate that the antenna structure 1102 formed around an open area 1160 need not be substantially uniform in thickness in various embodiments. It will be appreciated that the shape and dimensions of each open area 1160 may be configured to suit the intended application for the resulting RFID device 1100.

In some cases, an open area 1160 may be formed by, for example, an aluminum die-cutting process that may take place as part of a manufacturing process for a RFID device 1100. In such a process, a layer of aluminum may be placed on an adhesive that is formed in the desired shape of the antenna structure 1102. The aluminum may then be die-cut to the desired shape, thereby leaving only the aluminum that is attached to the adhesive in the shape of the antenna structure 1102. To create the open area 1160, the extra piece of aluminum that is now only over an area without adhesive may be removed by way of a vacuum or the like, as is known in the art. Alternatively, the open area 1160 may be formed by other processes that do not require removal of any material. An example of such a process would be printing a conductive ink in the desired shape of an antenna structure 1102.

Shapes of metal retained in the open area 1160 and electrically disconnected from the rest of the structure (i.e., the antenna structure 1102 and/or the impedance-matching loop 1104) by direct contact or proximity effects such as edge-to-edge capacitance will, in some circumstances, not cause significant alteration to the radiating properties of the RFID device 1100.

It should be noted that as the energy is concentrated in the external traces of the hollow dipole formed by the antenna 1102, the open area 1160 behaves as an “electrical null” zone. In an embodiment, adding a small amount of aluminum to this region (up to approximately 20% of the open area 315) may modify the antenna's 1102 physical appearance, but it will not appreciably affect its RF performance. In other words, the antenna 1102 will operate as though the added aluminum within the open space 1160 is absent. Adding a large amount of aluminum (i.e., more than approximately 20%) to the open area 1160 will not only modify the overall design significantly but may also reduce the antenna structure's RF capability to the point where the antenna 1160 will behave as a solid design.

FIGS. 11D and 11E illustrate two additional shapes of the open area 1160 formed within an antenna structure 1102 of an environmentally adaptable RFID device 1100, in accordance with an embodiment. FIG. 11D depicts an antenna structure 1102 that includes an open area 1160 that extends through the antenna structure at a narrow gap 1162. Alternatively, FIG. 11E depicts an antenna structure 1102 that includes an open area 1160 extending through the antenna structure 1102 at a wide gap 1164. Despite the antenna structures 1102 of FIGS. 11D and 11E having a narrow gap 1162 and wide gap 1164, respectively, in their outer perimeters, both still exhibit characteristics of a loop antenna. In each case, current will flow within the antenna structure 1102 around the inductive impedance-matching loop 1104 in the manner of a modified loop antenna.

FIG. 11F depicts a RFID device 1100 with an inductively coupled impedance-matching loop 1104 and an antenna structure 1102 that includes a first notch 1180a and a second notch 1180b. The notches may be made on the left and right edge. One or more notches may be formed. The first notch 1180a may have a first width W1 and a first length L1, while the second notch 1180b may have a second width W2 and a second length L2. The widths and lengths are selected to achieve an area of the notch that is less than 20% of the total area of the antenna 1102. These notches 1180a and 1180b may be designed to modify the electrical characteristics of the antenna structure 1102, potentially improving the environmentally adaptable RFID device 1100's performance in specific environments, such as by creating a controllable material-dependent directional property for the tag response.

As shown in FIG. 11F, an environmentally adaptable RFID device 1100 utilizes apertures 1185a and 1185b in the antenna structure 1102 to create material-dependent directional properties. The first aperture 1185a may be positioned on one side of the antenna structure 1102, while the second aperture 1185b may be located on the opposite side. These apertures may help control the formation of directional properties when the environmentally adaptable RFID device 1100 is placed in stacks of high-dielectric material.

The apertures 1185a and 1185b shown in FIG. 11G are rectangular, but it will be appreciated that any shape of apertures 1185a and 1185b are contemplated. In addition, the location, size, and shape of each aperture 1185a and 1185b may be the same and/or symmetrical, or may be different to suit the requirements of the application in which RFID device 1100 will be used. Using the example of rectangular apertures 1185a and 1185b, the ratio of length to width of each aperture 1185a and 1185b has been shown to assist in beam forming when the corresponding RFID device 1100 is placed in stacks of high-dielectric materials.

In one embodiment, the opposing ends 1128a, 1128b that extend from the bottom edge 1122 to the aperture 1110 to from a slot 1130 may have a non-parallel relationship as shown in FIG. 11H. Each opposing ends 1128a, 1128b is a mirror configuration and may have one or more curvatures. The closest separation or narrowest point between the curved ends 1128a, 1128b may be no less than 0.3 mm, e.g., no less than 0.4 mm or no less than 0.5 mm. The fullest separation or widest point between the curved ends should be less than the diameter of the impedance-matching loop 504. In one embodiment, the fullest separation may be no more than 10 mm, e.g., no more than 8 mm or no more than 5 mm. Without being bound by theory, it is believed that the curvatures along the opposing end 1128a, 1128b may enhance the microwave resistance of the antenna structure. Thus, a microwave stable antenna structure may be developed using the embodiments disclosed herein.

Although the antennas shown in FIG. 11H may have a solid configuration, the non-parallel slot may be used in the hollow configurations described herein.

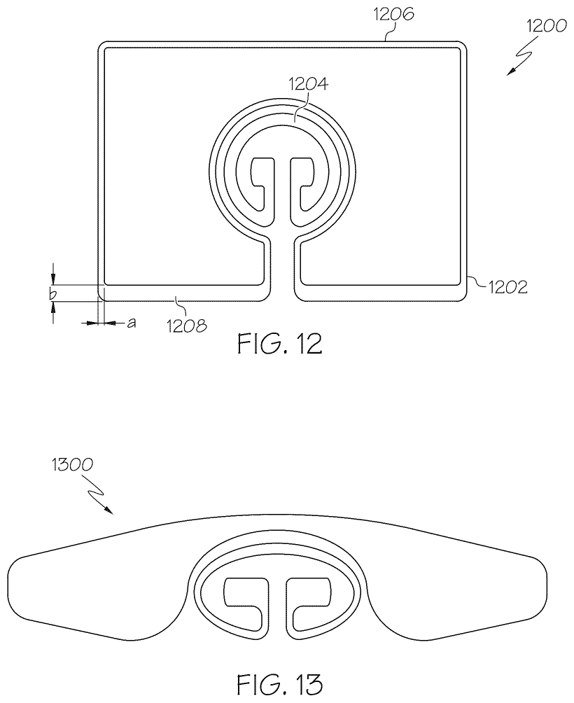

While FIG. 8 depicts the antenna structure as having a substantially uniform trace width throughout, other configurations are possible according to an embodiment. For example, FIG. 12 depicts an environmentally adaptable RFID device 1200 with an antenna structure 1202 surrounding an impedance-matching loop 1204. The antenna structure is formed from an antenna trace 1206. In one embodiment, the antenna trace 1206 includes a widened antenna trace 1208. As shown, the widened antenna area 1208 has a wider trace width (b) than the rest of the antenna trace 1206, which has a narrower trace width (a). Adjusting the trace width along the outer edges of the hollowed dipole formed by the antenna 1202 allows the antenna structure's radiation pattern to be reshaped, making it more directional. This enables improvement of the read range in desired directions while reducing performance in others, creating inlays with improved directional read capabilities. In some embodiments, the antenna structure 1202 will radiate (i.e., will form a radiation lobe) in the direction of the wider trace width when in proximity to a high-dielectric material.

While the environmentally adaptable RFID devices of have been depicted as substantially rectangular in overall shape, it will be readily appreciated by one skilled in the art that other shapes are possible while remaining consistent with the various embodiments disclosed herein. For example, square, circular or other shapes for antenna structures (which effectively define the overall shape of corresponding RFID devices) are possible. As just one example, FIG. 13 depicts a RFID device 1300 that is substantially in the form of an ellipse. One skilled in the art will appreciate that the RFID device 1300 of FIG. 13 is a substantially ellipse-shaped version of the substantially rectangular RFID device depicted in FIG. 5. Likewise, while not illustrated herein, the variations of RFID device illustrated in FIGS. 11A-11H may be imagined as substantially ellipse-shaped or, as noted above, substantially circular, square, etc., while still remaining consistent with the various embodiments disclosed herein.

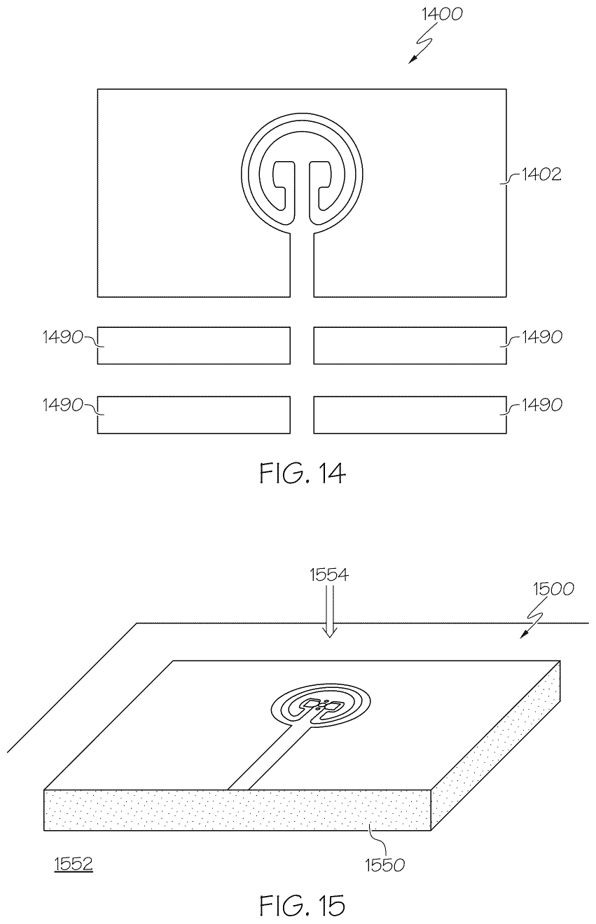

The following embodiments, as illustrated in FIGS. 14-18, describe the various structural factors that may be changed to achieve desired results. One or all can be combined, as is physically possible, in a single antenna design. Although these designs are shown with the wide arm dipole of FIGS. 5-7, it should appreciated that these designs may also be used with the hollow dipole antennas of FIGS. 8-10.

FIG. 14 illustrates an environmentally adaptable RFID device 1400 with an antenna structure 1402 that incorporates conductors 1490 outside the area of the antenna structure 1402. The number of conductors is not limited and in some embodiments, the RFID device 1400 may use from 2 to 10 conductors. The conductors 1490 may act as parasitic elements on the antenna structure 1402, and the coupling between the conductors 1490 and the antenna structure 1402 is dependent on the dielectric material environment and can improve performance and directional properties. Directional properties change depending on the dielectric material environment to provide maximum performance in a single or multiple directions representing the likely read directions for the RFID device (i.e., the direction(s) from which a RFID reader may attempt to interrogate the RFID device). As shown in FIG. 14, the conductors 1490 may be arranged below bottom edge of the antenna structure 1402, but other arrangements along the sides or top are possible in accordance with the various embodiments.

RFID devices shown herein comprising a RFID integrated circuit chip and an antenna may be adhered or otherwise affixed to a label. The label may be applied to the package containing the high-dielectric material. In some embodiments, the RFID device may be directly applied to the package without using a label. In some embodiments, the antenna may create at least one directional sensitivity pattern configured to intersect with a read aperture of a RFID reader. The antenna improves the read rate of the RFID device when the RFID device is placed on packages containing high-dielectric materials. In one embodiment, the RFID device is applied to a package containing a high-dielectric material the read rate of the RFID device may be greater than or equal to 75%, e.g., greater than or equal to 85% or greater than or equal to 95%. The location of the RFID device on the package may influence the read rate, with read rates being higher on the edges than the center and the top edge of the package generally having higher read rates.

In an embodiment, any of the RFID devices disclosed herein may be combined with a low-loss, low-dielectric (e.g., 1-2 εᵣ) spacer on one or both sides of the RFID device to create separation from high-dielectric materials. In many use cases, the spacer may be needed on both sides of the RFID device to maintain separation from both the package to which the RFID device is affixed, as well as to another package that may be placed on top of the RFID device (for example, as illustrated in FIGS. 3B-D). The stacking can be up to several packages high, and in some cases as many as six packages high, so the presence of a spacer that increases readability could be particularly useful in such situations. The spacer material could be, for example, various types of polyethylene (PE) foam, cavitated polypropylene (PP), polyethylene terephthalate (PET), paper, cardboard, or the like. In some embodiments, the thickness of the spacer is selected so the completed product (e.g., RFID device, the spacer, and the label to which both are attached) can pass through printers and applicators without issues. In such embodiments, the combined thickness of the spacer, the RFID device, and any other layers (e.g., facestock, adhesives, etc.) should be less than 51 mm, e.g., less than 45 mm, less than 40 mm, less than 35 mm, less than 25 mm or less than 20 mm, at least during the printing and application of an inlay or label of which the RFID device may be a part. It will be appreciated that the spacer may have dimensions that are the same or different than the label or the RFID device. In one embodiment, the spacer may be positioned substantially on the bottom and/or top of the RFID device, even if a label to which the RFID device is attached has a larger footprint. In another embodiment, the spacer may cover the entire area of the label.

FIG. 15 depicts a RFID device 1500 that has been attached, or placed adjacent to, a spacer 1550. FIG. 15 further depicts the RFID device 1500 being attached to a surface 1552 of a dielectric material or package with the spacer 1550 in between, typically by using an adhesive (not shown). As noted above, in an embodiment the spacer 1550 is comprised of a low-loss, low-dielectric material (e.g., 1-2 εᵣ). Although not shown in FIG. 15, the spacer 1550 may be encapsulated by a face layer or similar polymeric layer. This encapsulation may reduce or prevent delamination.

The spacer 1550 of FIG. 15 may, in one embodiment, resist compression forces that may occur substantially in the direction indicated by arrow 1554. In such an embodiment, the objective may be to maintain an amount of separation between the RFID device 1500 and the surface 1552. In another embodiment, when the RFID device 1500 is placed in a stack of packages, the material thickness of the spacer 1550 changes to allow the RFID device 1500 to provide improved performance and the radiation lobes (i.e., radiation pattern) required for desired performance.

In some embodiments, the spacer 1550 may be a low-density material comprising hollow spheres, air gaps or air pockets. In some embodiments, the spacer 1550 may be foamed polymeric film, cavitated polymeric films, patterned adhesives, foamed adhesives, or any combination thereof. In some embodiments, the spacer 1550 may be a topcoat, an adhesive, a primer, an ink layer or any combination thereof comprising hollow spheres including but not limited to polymeric beads, glass beads, glass bubbles or a combination thereof. The hollow spheres or foam or cavities create air gaps and air pockets in the spacer 1550, which in turn creates a low-density environment around the RFID device 1500. The low-density environment around the RFID device helps the RFID device to efficiently operate across a range of dielectric conditions, including high dielectric and conducting environments.

In some cases, the spacer may be a topcoat, an adhesive, a primer, an ink layer or any combination thereof, which is configured to expand upon exposure to an external stimulus. In such cases, the spacer may include expandable particles, foamable materials, or a combination thereof, which on exposure to external stimulus leads to expansion of the spacer. The external stimulus may be, but is not limited to, thermal, physical, radiation, electrical, sound, chemical, magnetic or any combination thereof. For example, in some embodiments the wireless label construction may be exposed to thermal stimuli, including but not limited to induction heating and IR lamps. Examples of physical stimuli may include but are not limited to pressure, vibrations, ultra-sonication, and any combination thereof. Examples of radiation stimuli include but are not limited to UV radiation, laser radiation, electron beam radiation, electromagnetic radiation and any combination thereof.

In some embodiments, the spacer may have a polymeric matrix comprising a polymer selected from starch, vinyl acetate ethylene dispersion, polyvinyl acetate, polyvinyl acetate, polyvinyl alcohol, dextrin stabilized polyvinyl acetate, polyvinyl acetate copolymers, vinyl acetate-ethylene copolymers, vinyl acrylic, styrene acrylic, acrylic, styrene butyl rubber, polyurethane or any combination thereof. In accordance with some embodiments of the present invention, the plasticizer may be selected from the group consisting of polyfunctional alcohol, polyoxyalkylene or polyoxyalkylene derivative (e.g. glycerol, dibenzoates such as diethylene glycol dibenzoate and dipropylene glycol dibenzoate), polyethylene glycol, polyethylene glycol monomethyl ether, polyethylene glycol monoethyl ether, polyethylene glycol dimethyl ether, polyethylene glycol diethyl ether, polypropylene glycol, polybutylene glycol or their copolymers or any combination thereof. The spacer, based on dry weight, may comprise from 20 to 70% by weight of the polymeric matrix and 15 to 50% by weight of the plasticizer, and from 25 to 60% by weight of expandable particles.

In some embodiments, the spacer may comprise an acrylic emulsion having a nonionic surfactant and expandable particles. The acrylic emulsion may comprise 35 to 98% by weight of an alkyl acrylate, 0 to 35% by weight of vinyl ester, 0 to 40% by weight of a diester of a dicarboxylic acid, and 0 to 10% of an unsaturated carboxylic acid. These % by weight are based on the total weight of the acrylic emulsion. The alkyl acrylate may preferably contain from about 4 to about 8 carbon atoms in the alkyl group, preferably 2-ethyl hexyl acrylate or butyl acrylate. The vinyl ester may preferably contain from 2 to about 16 carbon atoms in the alkyl chain of the ester, preferably vinyl acetate. Each alkyl group of the diester independently contains from about 6 to about 16 carbon atoms, with di-2-ethyl hexyl maleate or di-2-ethyl hexyl fumarate being preferred. The unsaturated carboxylic acid may contain from 3 to about 5 carbon atoms, preferably acrylic and/or methacrylic acid. The acrylic emulsion may have a glass transition temperature of less than about −30° C.

The acrylic emulsion may also contain a nonionic surfactant in an amount from 0.4 to 5% by weight of the acrylic emulsion. Suitable nonionic surfactants may include polyethylene polyoxypropylene block copolymers and nonionic emulsified waxes.

The expandable particles may include a polymeric shell and a core. In an embodiment, the expandable particles are thermally expandable particles. The polymeric shell may be made of polymers including but not limited to vinylidene chloride-acrylonitrile copolymers, polyvinyl alcohols, polyvinyl butyrals, polymethyl methacrylates, polyacrylonitriles, polyvinylidene chlorides, polysulfones, or combinations thereof. The core of the expandable may contain hydrocarbons, including but not limited to isobutane, isopentane, or other suitable blowing agents, which vaporize when heated, leading to particle expansion, which in turn increases the thickness and reduces the density of the spacer containing expandable particles.

Alternatively, the foamable materials, upon exposure to external stimuli, lead to foam generation through either physical foam generation or chemical foam generation. In the context used herein, “physical foam generation” refers to a process that involves injecting a gas into a liquid or polymer melt to create a foam due to a change in temperature, pressure, or other physical factors. The material's chemical composition remains the same. In the context used herein “chemical foam generation” refers to a chemical reaction generating gas, which in turn creates foam. The chemical reaction is initiated due to a change in temperature, pressure, or other physical factors. This change creates new substances with different chemical and physical properties. The foamable materials may include but are not limited to blowing agents, foaming agents, a two-component foaming material, surfactants, catalysts, photoacids generators, phase-changing material or any combination thereof. The foam generation leads to expansion of the spacer, resulting in increased thickness and reduced density.

In one embodiment, the spacer may include a particle or layer having a breakable protective layer separating an acid component and a base component. The breakable protective layer may be a silica material, wax, paraffin, or triglycerides that may be ruptured upon application of a force. This causes a rupturing of the contents which may be an organic acid, base or water, that interacts with other components in the polymer matrix to cause expansion. Suitable organic acids may include, but are not limited to, formic acid, acetic acid, propionic acid, butyric acid, lactic acid, malic acid, citric acid, tartaric acid, oxalic acid, succinic acid, glutaric acid, glycolic acid, and ascorbic acid. Suitable bases may include, but are not limited to, sodium bicarbonate, potassium bicarbonate, and calcium carbonate.

The increase in thickness of the spacer, either through expansion or foam generation, creates separation between the RFID device and the high dielectric and conductive environment. This separation, which may range from a less than a millimeter to several centimeters depending on the degree of expansion or foam generation, helps to reduce interference from high dielectric and conductive environments that might otherwise impair the performance of the RFID device.

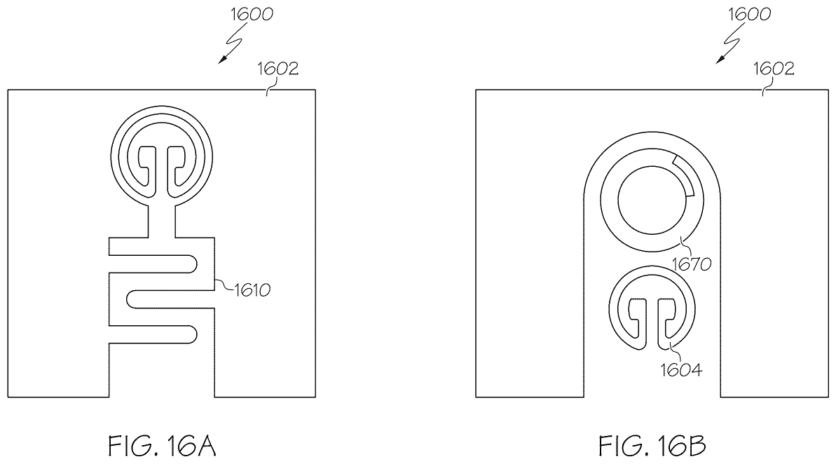

In some implementations, as depicted in FIG. 16A, the environmentally adaptable RFID device 1600 may include an interdigital capacitor 1610 within the antenna structure 1602. The interdigital capacitor 1610 may be shown as a series of interlocking finger-like projections extending from a stem of the antenna structure 1602. This configuration may allow for adjustable capacitance, potentially influencing the RFID device's resonant frequency and impedance-matching characteristics.

FIG. 16B shows an environmentally adaptable RFID device 1600 with an inductive impedance-matching loop 1604. The inductive impedance-matching loop 1604 may be positioned within the antenna structure 1602 and may be coupled to both the antenna structure 1602 and a split ring resonator 1670. This configuration may further enhance the RFID device's ability to adapt to different environmental conditions.

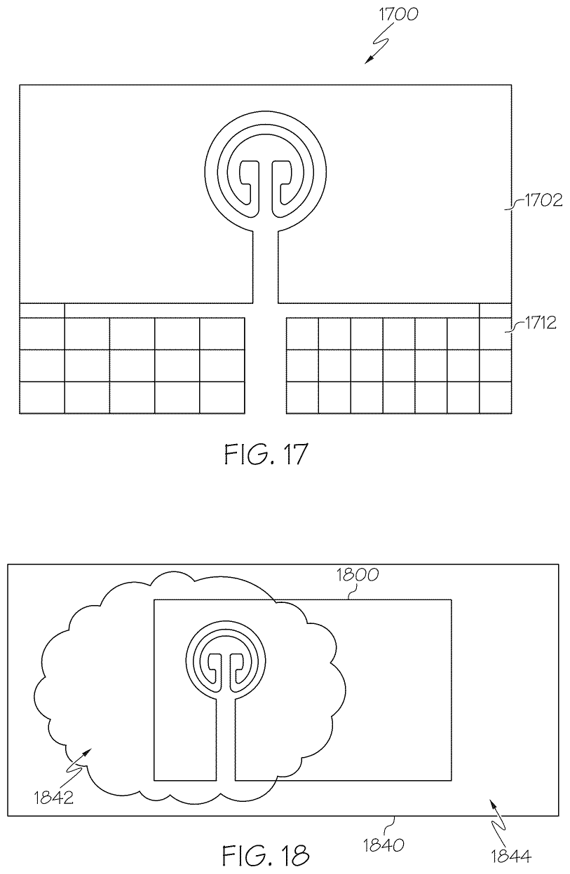

FIG. 17 depicts an environmentally adaptable RFID device 1700 with an antenna structure 1702 that includes an array of conductive elements 1712. The array of conductive elements 1712 may be arranged in a grid pattern below the antenna structure 1702 as shown in FIG. 17, or in another desirable location (e.g., above, or to either side of, antenna structure). Each of the conductive elements 1712 may be separated by gaps, which, in an embodiment, may be between 10 μm and 100 μm in width. The conductive elements 1712 may be interlocked or coupled together depending on the properties of the material (e.g., high-dielectric material) below the gap, allowing the antenna structure 1702 to adapt to circumstances where different parts of the antenna structure 1702 have different dielectric environments under it. This configuration may allow the environmentally adaptable RFID device 1700 to adapt its performance when placed on or near materials with varying dielectric properties.

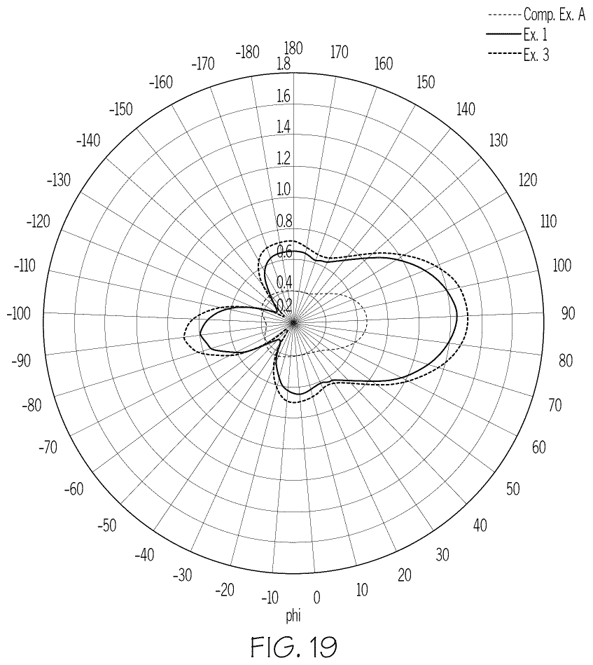

FIG. 18 depicts an environmentally adaptable RFID device 1800 positioned on a package 1840, wherein the package has two different environments, according to an embodiment. For example, the one portion of the environmentally adaptable RFID device 1800 may be adjacent to an area of high loss 1842, while the upper portion may be adjacent to an area of low loss 1844, such as air space. For example, if the package 1840 contains meat, the meat would represent the high-dielectric material, which corresponds to the area of high loss 1842. Areas where the meat does not fill the interior of the package 1840 would produce an air gap that corresponds to the area of low loss 1844. FIG. 18 depicts a RFID device 1800 with an asymmetric antenna structure that has a smaller dipole located over the area of high loss 1842 and a larger dipole located over the area of low loss 1842.

In some cases, the environmentally adaptable RFID device may utilize a low-loss, low-dielectric spacer, such as was discussed above in connection with FIG. 15, on both sides of the RFID device to create separation from multiple areas of high loss. For example, the spacer that is between the RFID device and the package to which it is affixed may create separation from an area of high loss that is present in that package, as was discussed above. The spacer that is adjacent to the top of RFID device may create separation from an area of high loss that is present in a package that is placed on top of the package to which the RFID device is affixed.

The environmentally adaptable RFID device may also incorporate one or more activatable isolating layers that can change their physical dimensions post-application. These isolating layers may be activated by thermal, ultraviolet, or mechanical force. The activation may cause the isolating layers to expand in one or more dimensions, potentially improving the separation between the antenna structure and the surrounding high-dielectric materials.

The above-disclosed impedance-matching mechanisms may work together or independently to help the environmentally adaptable RFID device maintain desirable levels of performance across a range of dielectric environments. In some cases, the environmentally adaptable RFID device may achieve environmental adaptability through the interaction of various elements, either alone or in any combination.

The antenna structure, impedance-matching mechanisms, and adaptive radiation patterns may work together to optimize performance in different environments.

### EXAMPLES

The following examples are provided solely to illustrate the present invention and are not intended to limit the scope of the invention, described herein.

### Examples 1-3—Aspect Ratio on Wide Arm Dipole Antennas

RFID devices were built with antennas having a construction as shown in FIG. 5. Each of the RFID devices have a perimeter of 146 mm. The RFID devices built and tested using simulation software, Ansys HFSS. The RFID devices were placed on a label and attached in the center of a package having a foam tray containing chicken wrapped in a polyamide film. Another package of meat was placed above the RFID device tested as demonstrated in FIG. 3C. The model used to test the total efficiency and radiation efficiency. The foam tray had a thickness of 4.5 mm and a relative permittivity εr=1.1, loss δ=0.046. The polyamide film had a thickness of 0.02 mm and a relative permittivity εr=4.3, loss δ=0.004. The chicken had a dimension of 380 mm×225 mm with a thickness of 40 mm. The relative permittivity of the chicken was εr=56.8, loss δ=0.38.

The aspect ratio (width in x-axis/height in y-axis) is reported in Table 1 for each RFID device tested. The total efficiency % and radiation efficiency % at 902 to 928 MHz as well as matching efficiency (Tau) were tested and reported in Table 1.

TABLE 1

| | | | | | | |
|---|---|---|---|---|---|---|
| | Axial | Width | Height | Total | Rad | |
| Example | Ratio | (mm) | (mm) | eff. % | eff. % | Tau |

Inventive Example

| | | | | | | |
|---|---|---|---|---|---|---|
| 1 | 1.52 | 44 | 29 | 0.077 | 0.124 | 0.826 |
| 2 | 1.92 | 48 | 25 | 0.100 | 0.132 | 0.827 |
| 3 | 2.48 | 52 | 21 | 0.094 | 0.153 | 0.766 |

Comparative Examples

| | | | | | | |
|---|---|---|---|---|---|---|
| A | 0.70 | 30 | 43 | 0.0723 | 0.0908 | 0.848824 |
| B | 0.78 | 32 | 41 | 0.0739 | 0.0944 | 0.858936 |
| C | 0.97 | 36 | 37 | 0.076 | 0.1061 | 0.867173 |
| D | 1.21 | 40 | 33 | 0.0785 | 0.1169 | 0.85416 |

As shown in Table 1, increasing the axial ratio improved the radiation efficiency which increased the read range. In contrast, lowering the axial ratio of the antenna with same perimeter dropped the radiation efficiency as well as the read range.

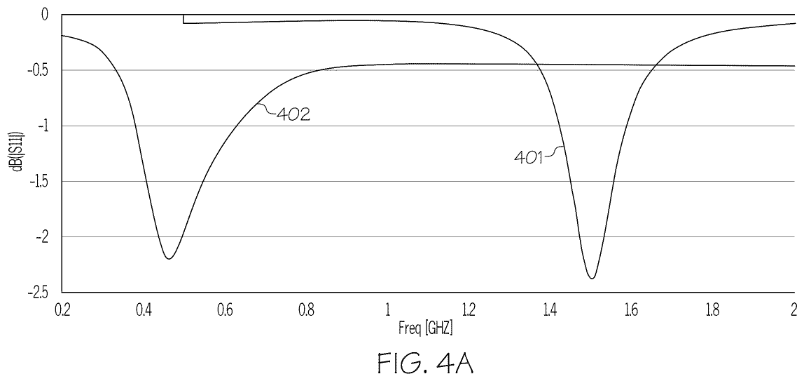

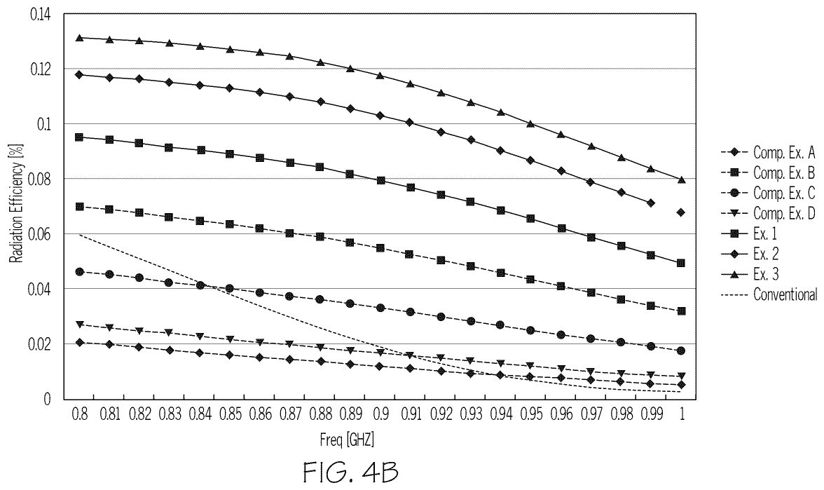

To illustrate how specific efficiency and frequency response characteristics may differ in different environments, FIG. 4A provides a graph 400 of reflection coefficients (“S11” in FIG. 4A) for Example 1. The graph of reflection coefficients includes a plot of a RFID device having the antenna of Example 1 in free air 401 and a plot of a RFID device having the antenna of Example 1 between two high-dielectric materials 402. The plot of the RFID device having the antenna of Example on high-dielectric material 402 may show a single, broader resonance at a lower frequency compared to the plot of the same antenna in free air 401.

FIG. 4B depicts total radiation efficiency for various antenna designs across a frequency range. The graph of total radiation efficiency shows the performance of the examples 1-3 and comparative examples A-D, along with a conventional dipole antenna. The inventive examples having an adaptable RFID device demonstrates the highest total radiation efficiency and widest frequency bandwidth as compared to the comparative examples.

The RFID devices tested in Table 1 were placed in the middle of the package containing meat. To test the effect of label placement, the same RFID devices were placed near the top edge of the package on the top surface near the RFID reader as well as the bottom edge of the package on the top surface away from the RFID reader. The results are reported in Table 2.

TABLE 2

| | Top Edge | | | Bottom Edge | | |
|---|---|---|---|---|---|---|
| | Total | Rad | | Total | Rad | |
| | eff. % | eff. % | Tau | eff. % | eff. % | Tau |
| | @ 910 | @ 910 | @ 910 | @ 910 | @ 910 | @ 910 |
| Example | MHz | MHz | MHz | MHz | MHz | MHz |

Inventive Examples

| | | | | | | |
|---|---|---|---|---|---|---|
| 1 | 0.171 | 0.246 | 0.853 | 0.118 | 0.167 | 0.863 |
| 2 | 0.178 | 0.302 | 0.810 | 0.090 | 0.144 | 0.798 |
| 3 | 0.244 | 0.359 | 0.761 | 0.087 | 0.144 | 0.778 |

Comparative Examples

| | | | | | | |
|---|---|---|---|---|---|---|
| A | 0.079 | 0.097 | 0.674 | 0.108 | 0.134 | 0.665 |
| B | 0.079 | 0.096 | 0.815 | 0.115 | 0.139 | 0.715 |
| C | 0.105 | 0.134 | 0.854 | 0.129 | 0.155 | 0.733 |
| D | 0.139 | 0.187 | 0.864 | 0.119 | 0.165 | 0.870 |

At the top edge of the package the inventive RFID devices showed a notable improvement in radiation efficiency over the comparative examples. At the top edge of the package the antennas tended to radiate outwards toward the edge e.g., at phi=90° as seen in FIG. 19, which plots examples 1 and 3 with comparative example A. In FIG. 19, 90° is antenna top and −90° is antenna bottom. Hence, inlays with higher axial ratios, examples 1-3, whose radiation pattern is already skewed in the phi=90° direction radiated at a higher magnitude when placed close to the top edge. Thus, placing the label near the top edge as shown in Table 2, outperformed those placed in the middle position in Table 1. While the results at the bottom edge showed improvements, overall the inventive examples still outperformed the comparative examples.

### Example 4—Reduced Magnetic Field Interaction in Y-Axis

Using the RFID device from comparative example A, the total efficiency %, and radiation efficiency %, was improved by reduced magnetic field interaction in Y-axis above the impedance loop in the top region. The same model and testing software from Examples 1-3 was used. The height of comparative example A is 18.4 mm. By increasing this height in Example 4, performance was improved as shown in Table 3. The aspect ratio (0.7) and perimeter (146 mm) remained the same for the devices reported in Table 3. The RFID devices were placed the top edge of the package as described above.

TABLE 3

| | | | | | |
|---|---|---|---|---|---|
| | | | Total | Rad | |
| | | | eff. % | eff. % | Tau |
| | Gap Top | Gap Bottom | @ 910 | @ 910 | @ 910 |
| Example | Height (mm) | Height (mm) | MHz | MHz | MHz |

Inventive Example

| | | | | | |
|---|---|---|---|---|---|
| 4 | 23.4 | 3.57 | 0.0658 | 0.1159 | 0.506 |

Comparative Examples

| | | | | | |
|---|---|---|---|---|---|
| A | 18.4 | 7.57 | 0.079 | 0.097 | 0.674 |
| E | 1.4 | 25.57 | 0.0102 | 0.0145 | 0.924 |

By increasing the gap top height, the gap bottom height is also reduced. Accordingly, increasing the gap top height and decreasing the gap bottom height improved the radiation efficiency for example 4. This improvement in radiation efficiency over comparative examples A and E may be due to the decreased magnetic field interaction between the top edges of the inner and outer dipoles as the gap increases or due to the reduction in magnetic field interaction between the two ends of the outer dipole below the inner dipole as its length decreases.

While the effect of adjusting the gap top height and gap bottom height was shown to improve the performance of comparative example A, it is expected that such improvements would also be achieved with Examples 1-3.

### Example 5—Reduced Magnetic Field Interaction in X-Axis

Three RFID devices were tested to demonstrate the effect of reducing the magnetic field interaction in the x-axis. The same model and testing software from Examples 1-3 was used. Each of the RFID devices were tested with gap top height of 1.4 mm to eliminate any influence of the top region on the magnetic field. As shown above in Table 3, comparative example E with 1.4 mm in top gap height performed poorly. To increase the area in the X-axis, the aspect ratio was increased without changing the perimeter. Each of the three RFID devices has a similar perimeter of 146 mm. Table 4 reports the results for the inventive and comparative examples. The RFID devices were placed the top edge of the package as described above.

TABLE 4

| | | | | | |
|---|---|---|---|---|---|
| | | | Total | Rad | |
| | | | eff. % | eff. % | Tau |
| | Aspect | Gap Bottom | @ 910 | @ 910 | @ 910 |
| Example | Ratio | Height (mm) | MHz | MHz | MHz |

Inventive Example

| | | | | | |
|---|---|---|---|---|---|
| 5 | 2.41 | 3.57 | 0.0936 | 0.153 | 0.828 |

Comparative Examples

| | | | | | |
|---|---|---|---|---|---|
| E | 0.7 | 25.57 | 0.0102 | 0.0145 | 0.924 |
| F | 1.52 | 11.57 | 0.0523 | 0.090. | 0.652 |

Table 4 shows that decreasing the gap bottom height while increasing the aspect ratio (keeping the perimeter constant) significantly improves the radiation efficiency. Lowering of the magnetic field interactions of the left and right regions in the x-axis of the antenna was achieved by widening and decreasing the magnetic field interaction in the bottom region. As shown, increasing the aspect ratio by moving the side edges of the antenna away from the inner impedance loop and decreasing the length of the gap bottom height reduced the destructive magnetic field interaction and shapes the radiation pattern such that the RFID device of example 5 will radiate over a longer range away from the top edge of the package.

While the effect of adjusting the aspect ratio and gap bottom height was shown to improve the performance of comparative example E, it is expected that such improvements would also be achieved with Examples 1-3.

### Examples 6-9—Aspect Ratio on Hollow Dipole Antennas

RFID devices were built with antennas with a hollow dipole antenna having a construction as shown in FIG. 8. The same model and testing software from Examples 1-3 was used. Each of the RFID devices have a perimeter of 158 mm. The RFID devices were placed on a label and attached in the center of a package containing meat. Another package of meat was placed above the RFID device tested as demonstrated in FIG. 3C. The aspect ratio (width in x-axis/height in y-axis) is reported in Table 5 for each RFID device tested. The total efficiency % and radiation efficiency % at 910 MHz as well as matching efficiency (Tau) were tested and reported in Table 5.

TABLE 5

| | | | | | | |
|---|---|---|---|---|---|---|
| | | | | Total | Rad | |
| | | | | eff. % | eff. % | Tau |
| | Axial | Width | Height | @ 910 | @ 910 | @ 910 |
| Example | Ratio | (mm) | (mm) | MHz | MHz | MHz |

Inventive Example

| | | | | | | |
|---|---|---|---|---|---|---|
| 6 | 1.26 | 44 | 35 | 0.057 | 0.117 | 0.653 |
| 7 | 1.55 | 48 | 31 | 0.092 | 0.147 | 0.686 |
| 8 | 1.93 | 52 | 27 | 0.095 | 0.178 | 0.671 |
| 9 | 2.04 | 53 | 26 | 0.106 | 0.187 | 0.677 |

Comparative Examples

| | | | | | | |
|---|---|---|---|---|---|---|
| G | 0.68 | 32 | 47 | 0.040 | 0.079 | 0.558 |
| H | 0.84 | 36 | 43 | 0.044 | 0.085 | 0.555 |
| I | 1.03 | 40 | 39 | 0.045 | 0.097 | 0.586 |

Similar to Examples 1-3, having a higher aspect ratio for hollow dipole antenna in examples 6-9 provided for significant improvements for the hollow dipole antennas.

The RFID devices tested in Table 5 were placed in the middle of the package containing meat. To test the effect of label placement, the same RFID devices were placed near the top edge of the package on the top surface near the RFID reader as well as the bottom edge of the package on the top surface away from the RFID reader and the results are reported in Table 6.

TABLE 6

| | Top Edge | | | Bottom Edge | | |
|---|---|---|---|---|---|---|
| | Total | Rad | | Total | Rad | |
| | eff. % | eff. % | Tau @ | eff. % | eff. % | Tau @ |
| | @ 910 | @ 910 | 910 | @ 910 | @ 910 | 910 |
| Example | MHz | MHz | MHz | MHz | MHz | MHz |

Inventive Examples

| | | | | | | |
|---|---|---|---|---|---|---|
| 6 | 0.167 | 0.266 | 0.658 | 0.065 | 0.119 | 0.683 |
| 7 | 0.193 | 0.329 | 0.695 | 0.082 | 0.147 | 0.699 |
| 8 | 0.218 | 0.385 | 0.671 | 0.098 | 0.173 | 0.700 |
| 9 | 0.209 | 0.385 | 0.672 | 0.101 | 0.179 | 0.696 |

Comparative Examples

| | | | | | | |
|---|---|---|---|---|---|---|
| G | 0.050 | 0.096 | 0.532 | 0.053 | 0.104 | 0.573 |
| H | 0.067 | 0.128 | 0.554 | 0.055 | 0.109 | 0.592 |
| I | 0.100 | 0.188 | 0.580 | 0.056 | 0.111 | 0.622 |

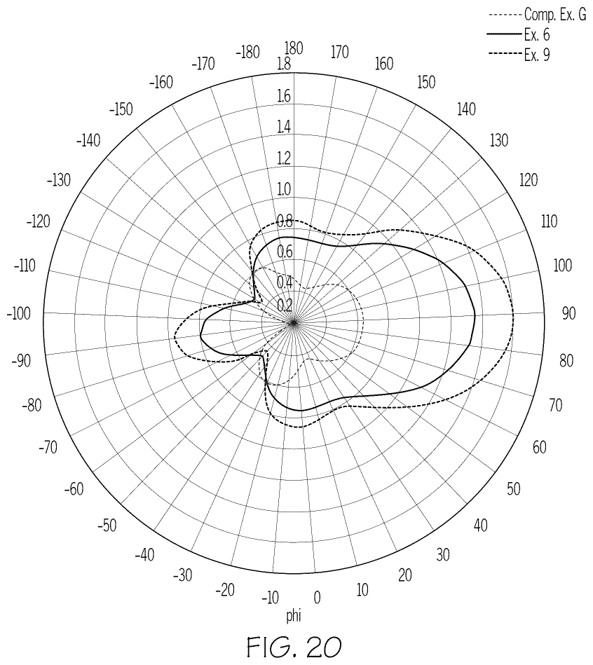

Hollow dipole antennas, when placed both at the top and the bottom edges of the package, showed radiation efficiency improvement as more radiation is able to escape from the edge into the surrounding. Examples 6-9 had the highest radiation efficiency and read range when placed on the top edge with a high axial ratio. The antennas tend to radiate outwards toward the edge e.g. at phi=90° as seen in FIG. 20, which plots examples 6 and 9 with comparative example G. In FIG. 20, 90° is antenna top and −90° is antenna bottom. The range radiation pattern shown in FIG. 20 is bent toward the xy plane away from the z plane. The results at the bottom edge maintained good performance and overall the inventive examples outperformed the comparative examples.

### Example 10—Reduced Magnetic Field Interaction in Y-Axis

The same model and testing software from Examples 1-3 was used. Using the RFID device from comparative example G, the radiation efficiency % was shown to improve by reduced magnetic field interaction in Y-axis above the impedance loop in the top region. The height of comparative example G is 13.6 mm. By increasing this height in Example 4, there was improved performance as shown in Table 7. The aspect ratio (0.68) and perimeter (158 mm) remained the same for the devices reported in Table 7. The RFID devices were placed the top edge of the package as described above.

TABLE 7

| | | | | | |
|---|---|---|---|---|---|
| | | | Total | Rad | |
| | | | eff. % | eff. % | Tau |
| | Gap Top | Gap Bottom | @ 910 | @ 910 | @ 910 |
| Example | Height (mm) | Height (mm) | MHz | MHz | MHz |

Inventive Example

| | | | | | |
|---|---|---|---|---|---|
| 10 | 21.6 | 5.4 | 0.0592 | 0.126 | 0.5389 |

Comparative Examples

| | | | | | |
|---|---|---|---|---|---|
| G | 13.6 | 12.4 | 0.050 | 0.096 | 0.532 |
| J | 1.6 | 25.4 | 0.0593 | 0.113 | 0.6602 |

By increasing the gap top height, the gap bottom height is also reduced. Accordingly, increasing the gap top height and decreasing the gap bottom height improves the radiation efficiency for example 10 over comparative examples G and J. This improvement in radiation efficiency may be due to the decreased magnetic field interaction between the top edges of the inner and outer dipoles as the gap increases or due to the reduction in magnetic field interaction between the two ends of the outer dipole below the inner dipole as its length decreases.

While the effect of adjusting the gap top height and gap bottom height was shown to improve the performance of comparative example G, it is expected that such improvements would also be achieved with Examples 6-9.

### Example 11—Reduced Magnetic Field Interaction in X-Axis

Three RFID devices were tested to demonstrate the effect of reducing the magnetic field interaction in the x-axis. The same model and testing software from Examples 1-3 was used. Each of the RFID devices were tested with gap top height of 1.6 mm to eliminate any influence of the top region on the magnetic field. As shown above in Table 8, comparative example E with 1.6 mm in top gap height, performed poorly. To increase the area in the X-axis, the aspect ratio was increased without change the perimeter. Each of the three RFID devices has a similar perimeter of 158 mm. Table 8 reports the results for the inventive and comparative examples. The RFID devices were placed the top edge of the package as described above.

TABLE 8

| | | | | | |
|---|---|---|---|---|---|
| | | | Total | Rad | |
| | | | eff. % | eff. % | Tau |
| | Aspect | Gap Bottom | @ 910 | @ 910 | @ 910 |
| Example | Ratio | Height (mm) | MHz | MHz | MHz |

Inventive Example

| | | | | | |
|---|---|---|---|---|---|
| 11 | 2.1 | 5.4 | 0.106 | 0.187 | 0.676 |

Comparative Examples

| | | | | | |
|---|---|---|---|---|---|
| J | 0.68 | 25.4 | 0.0593 | 0.113 | 0.660 |
| K | 1.26 | 13.4 | 0.0580 | 0.117 | 0.652 |

Maintaining the gap bottom height at g=1.6 mm and increasing the aspect ratio as shown in Example 11 improved the radiation efficiency. Increasing the aspect ratio by moving the x-axis edges of the antenna away from the inner impedance loop and decreasing the gap bottom height reduced the destructive magnetic field interaction and shapes the radiation pattern such that the RFID device will radiate over a longer range away from the top edge of the meat. Hence, RFID devices with high aspect ratios of Example 11 had higher radiation efficiency and read range. While the effect of changing the gap top height and gap bottom height was shown to improve the performance of comparative example G, it is expected that such improvements would also be achieved with Examples 6-9.

A number of implementations have been described. Nevertheless, it will be understood that various modifications may be made without departing from the spirit and scope of the disclosure. Accordingly, other implementations are within the scope of the following claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A Radio Frequency Identification (RFID) antenna comprising:
an impedance-matching loop having straps for connecting an integrated circuit chip at each end of the impedance-matching loop, wherein the ends of the impedance-matching loop terminate within the impedance-matching loop; and
an antenna comprising:
a curved inner edge surrounding at least a portion of the impedance-matching loop and separated from the impedance-matching loop by a gap,
an outer edge comprising a top edge and a bottom edge on a y-axis of the antenna, and a left edge and a right edge on a x-axis of the antenna,
opposing ends extending from the bottom portion to the curved inner edge,
a top antenna region arranged between the top portion and the curved inner edge;
a bottom antenna region arranged along the opposing ends and being between the bottom edge and the curve inner edge;
a left antenna region arranged to extend from the left edge to the curved inner edge;
a right antenna region arranged to extend from the right edge to the curved inner edge;
wherein the top antenna region has a reduced magnetic field interaction in the y-axis; and/or
wherein the bottom antenna region has a reduced magnetic field interaction in the y-axis; and/or
wherein the left antenna region and/or the right antenna region has a reduced magnetic field interaction in the x-axis.

2. The RFID antenna of claim 1, wherein the impedance-matching loop has a circular configuration.

3. The RFID antenna of claim 2, wherein the curved inner edge has a shape that corresponds to the circular configuration.

4. The RFID antenna of claim 1, wherein the top portion is non-meandering.

5. The RFID antenna of claim 1, wherein the height of the top antenna region is at least three times the height of the bottom antenna region.

6. The RFID antenna of claim 1, wherein the height of the bottom antenna region is less than to 6 mm.

7. The RFID antenna of claim 1, wherein the antenna has an aspect ratio of width to height being greater than 1.6.

8. The RFID antenna of claim 1, wherein the antenna comprises a solid antenna.

9. The RFID antenna of claim 8, wherein the solid antenna comprises less than 20% of an open area.

10. The RFID antenna of claim 1, wherein the antenna comprises an antenna trace along the outer edge, wherein the antenna trace has a width ranges from 0.3 mm to 3 mm.

11. The RFID antenna of claim 10, wherein the antenna trace on at least one of the outer edge is wider than the remaining portion of the antenna trace.

12. The RFID antenna of claim 1, wherein the antenna has a directional sensitivity pattern configured to intersect with a read aperture of a RFID reader.

13. The RFID antenna of claim 1, wherein the opposing ends are separated by a slot, wherein the width of the slot ranges from 0.3 mm to 3 mm.

14. The RFID antenna of claim 1, comprising a spacer layer adjacent to one side of the antenna.

15. A Radio Frequency Identification (RFID) device comprising:
an RFID integrated circuit chip; and
an antenna comprising:
an impedance-matching loop having straps for connecting an integrated circuit chip at each end of the impedance-matching loop, wherein the ends of the impedance-matching loop terminate within the impedance-matching loop; and
an antenna comprising:
a curved inner edge surrounding at least a portion of the impedance-matching loop and separated from the impedance-matching loop by a gap,
an outer edge comprising a top edge and a bottom edge on a y-axis of the antenna, and a left edge and a right edge on a x-axis of the antenna,
opposing ends that extend from the bottom portion to the curved inner edge,
a top antenna region arranged between the top portion and the curved inner edge;
a bottom antenna region arranged along the opposing ends and being between the bottom edge and the curve inner edge;
a left antenna region arranged to extend from the left edge to the curved inner edge;
a right antenna region arranged to extend from the right edge to the curved inner edge;
wherein the top antenna region has a reduced magnetic field interaction in the y-axis; and/or
wherein the bottom antenna region has a reduced magnetic field interaction in the y-axis; and/or
wherein the left antenna region and/or the right antenna region has a reduced magnetic field interaction in the x-axis.

16. The RFID device of claim 15, wherein the RFID device is applied to a label having at least one adhesive surface.

17. The RFID device of claim 15, wherein the label is applied to a package containing a high-dielectric material.

18. The RFID device of claim 15, wherein high-dielectric material has a relative permittivity from 10 to 60.

19. The RFID device of claim 15, wherein the RFID device is applied to a package containing a high-dielectric material.

20. The RFID device of claim 15, wherein the read rate of the RFID device is greater than or equal to 75%.
